(19) United States
(12) Patent Application Publication
(10) Pub. No.: US 2025/0168831 A1
(43) Pub. Date: May 22, 2025

(54) INFORMATION CONFIGURATION METHOD AND APPARATUS, TERMINAL, NETWORK-SIDE DEVICE, AND READABLE STORAGE MEDIUM

(71) Applicant: VIVO MOBILE COMMUNICATION CO., LTD., Dongguan (CN)

(72) Inventors: Chaojun ZENG, Dongguan (CN); Lihui WANG, Dongguan (CN)

(73) Assignee: VIVO MOBILE COMMUNICATION CO., LTD., Dongguan (CN)

(21) Appl. No.: 19/033,385

(22) Filed: Jan. 21, 2025

Related U.S. Application Data
(63) Continuation of application No. PCT/CN2023/107886, filed on Jul. 18, 2023.

(30) Foreign Application Priority Data
Jul. 25, 2022 (CN) 202210879974.6

(51) Int. Cl. H04W 72/0446; H04L 5/00; H04W 72/21

(52) U.S. Cl. CPC H04W 72/0446; H04L 5/0048; H04W 72/21

(57) ABSTRACT

This application provides an information configuration method and apparatus, a terminal, a network-side device, and a readable storage medium. The information configuration method includes: receiving, by a terminal, first configuration information from a network-side device. In the first configuration information, a maximum of M sets of configuration information are configured for a single Sounding Reference Signal (SRS) resource. Each set of configuration information corresponds to a time domain unit meeting a specific requirements, and M is an integer greater than 1. The first configuration information is used for configuring a first object. The first object, after being configured, corresponds to a time domain unit meeting a specific requirement. The first object includes at least one of the following: at least two SRS resource sets or at least two SRS configurations.

### CROSS-REFERENCE TO RELATED APPLICATIONS

This application is a continuation of International Application No. PCT/CN 2023/107886, filed on Jul. 18, 2023, which claims priority to Chinese Patent Application No. 202210879974.6, filed on Jul. 25, 2022. The entire contents of each of the above-referenced applications are expressly incorporated herein by reference.

### TECHNICAL FIELD

This application pertains to the field of communication technologies, and specifically, relates to an information configuration method and apparatus, a terminal, a network-side device, and a readable storage medium.

### BACKGROUND

Currently, a flexible duplex mode is proposed, to more flexibly utilize limited spectrum resources, dynamically match service requirements, and improve resource utilization and data transmission performance such as uplink coverage, delay, etc. The flexible duplex mode is as follows: network-side full duplex, where uplink transmission and downlink transmission can be simultaneously performed in different frequency domain positions at a same time; and terminal-side half duplex, which is consistent with Time Division Duplex (TDD), where only uplink transmission or downlink transmission can be performed at one moment, and uplink transmission and downlink transmission cannot be simultaneously performed. In the flexible duplex mode, valid uplink resources exist in both a downlink symbol and an uplink symbol of a TDD frame structure. However, the two types of uplink resources correspond to different valid bandwidth, cause or are subject to different interference, and have different requirements for Sounding Reference Signal (SRS) transmissions. If SRS transmissions are performed based on a same configuration, SRS transmission performance may be affected.

### SUMMARY

Embodiments of this application provide an information configuration method and apparatus, a terminal, a network-side device, and a readable storage medium.

According to a first aspect, an information configuration method is provided, including:
receiving, by a terminal, first configuration information from a network-side device, where
in the first configuration information, a maximum of M sets of configuration information are configured for a single SRS resource, each set of configuration information corresponds to a time domain unit meeting a specific requirements, and M is an integer greater than 1; and/or
the first configuration information is used for configuring a first object, the first object, after being configured, corresponds to a time domain unit meeting a specific requirement, and the first object includes at least one of the following: at least two SRS resource sets or at least two SRS configurations.

According to a second aspect, an information configuration method is provided, including:
sending, by a network-side device, first configuration information to a terminal, where
in the first configuration information, a maximum of M sets of configuration information are configured for a single SRS resource, each set of configuration information corresponds to a time domain unit meeting a specific requirements, and M is an integer greater than 1; and/or
the first configuration information is used for configuring a first object, the first object, after being configured, corresponds to a time domain unit meeting a specific requirement, and the first object includes at least one of the following: at least two SRS resource sets or at least two SRS configurations.

According to a third aspect, an information configuration apparatus is provided, applied to a terminal and including:
a receiving module, configured to receive first configuration information from a network-side device, where
in the first configuration information, a maximum of M sets of configuration information are configured for a single SRS resource, each set of configuration information corresponds to a time domain unit meeting a specific requirements, and M is an integer greater than 1; and/or
the first configuration information is used for configuring a first object, the first object, after being configured, corresponds to a time domain unit meeting a specific requirement, and the first object includes at least one of the following: at least two SRS resource sets or at least two SRS configurations.

According to a fourth aspect, an information configuration apparatus is provided, applied to a network-side device and including:
a sending module, configured to send first configuration information to a terminal, where
in the first configuration information, a maximum of M sets of configuration information are configured for a single SRS resource, each set of configuration information corresponds to a time domain unit meeting a specific requirements, and M is an integer greater than 1; and/or
the first configuration information is used for configuring a first object, the first object, after being configured, corresponds to a time domain unit meeting a specific requirement, and the first object includes at least one of the following: at least two SRS resource sets or at least two SRS configurations.

According to a fifth aspect, a terminal is provided, where the terminal includes a processor and a memory, the memory stores a program or instructions capable of running on the processor, and when the program or instructions are executed by the processor, the steps of the method according to the first aspect are implemented.

According to a sixth aspect, a terminal is provided, including a processor and a communication interface. The communication interface is configured to receive first configuration information from a network-side device, where in the first configuration information, a maximum of M sets of configuration information are configured for a single SRS resource, each set of configuration information corresponds to a time domain unit meeting a specific requirements, and M is an integer greater than 1; and/or the first configuration information is used for configuring a first object, the first object, after being configured, corresponds to a time domain unit meeting a specific requirement, and the first object includes at least one of the following: at least two SRS resource sets or at least two SRS configurations.

According to a seventh aspect, a network-side device is provided, where the network-side device includes a processor and a memory, the memory stores a program or instructions capable of running on the processor, and when the program or instructions are executed by the processor, the steps of the method according to the second aspect are implemented.

According to an eighth aspect, a network-side device is provided, including a processor and a communication interface. The communication interface is configured to send first configuration information to a terminal, where in the first configuration information, a maximum of M sets of configuration information are configured for a single SRS resource, each set of configuration information corresponds to a time domain unit meeting a specific requirements, and M is an integer greater than 1; and/or the first configuration information is used for configuring a first object, the first object, after being configured, corresponds to a time domain unit meeting a specific requirement, and the first object includes at least one of the following: at least two SRS resource sets or at least two SRS configurations.

According to a ninth aspect, a communication system is provided, including a terminal and a network-side device. The terminal may be configured to perform the steps of the information configuration method according to the first aspect. The network-side device may be configured to perform the steps of the information configuration method according to the second aspect.

According to a tenth aspect, a readable storage medium is provided, where the readable storage medium stores a program or instructions, and when the program or instructions are executed by a processor, the steps of the method according to the first aspect are implemented, or the steps of the method according to the second aspect are implemented.

According to an eleventh aspect, a chip is provided, where the chip includes a processor and a communication interface, the communication interface is coupled to the processor, and the processor is configured to run a program or instructions to implement the steps of the method according to the first aspect, or implement the steps of the method according to the second aspect.

According to a twelfth aspect, a computer program or program product is provided, where the computer program or program product is stored in a storage medium, and the computer program or program product is executed by at least one processor to implement the steps of the method according to the first aspect, or implement the steps of the method according to the second aspect.

In the embodiments of this application, a terminal may receive first configuration information from a network-side device, where in the first configuration information, a maximum of M sets of configuration information are configured for a single SRS resource, each set of configuration information corresponds to a time domain unit meeting a specific requirements, and M is an integer greater than 1; and/or the first configuration information is used for configuring a first object, the first object, after being configured, corresponds to a time domain unit meeting a specific requirement, and the first object includes at least one of the following: at least two SRS resource sets or at least two SRS configurations. Therefore, for SRS transmission, parameters, such as a time domain/frequency domain/code domain parameter, a power-related parameter, and a spatial relation-related parameter, that match characteristics of different uplink resources may be configured for the uplink resources. In this way, different uplink resources are fully utilized based on characteristics of the uplink resources, to ensure SRS transmission performance.

### BRIEF DESCRIPTION OF THE DRAWINGS

FIG. 1 is a block diagram of a wireless communication system to which embodiments of this application are applicable;

FIG. 2 is a schematic diagram of a flexible duplex mode according to an embodiment of this application;

FIG. 3 is a flowchart of an information configuration method according to an embodiment of this application;

FIG. 4 is a schematic diagram of SRS transmission according to an embodiment of this application;

FIG. 5 is a flowchart of another information configuration method according to an embodiment of this application;

FIG. 6 is a schematic structural diagram of an information configuration apparatus according to an embodiment of this application;

FIG. 7 is a schematic structural diagram of another information configuration apparatus according to an embodiment of this application;

FIG. 8 is a schematic structural diagram of a communication device according to an embodiment of this application;

FIG. 9 is a schematic structural diagram of a terminal according to an embodiment of this application; and

FIG. 10 is a schematic structural diagram of a network-side device according to an embodiment of this application.

### DETAILED DESCRIPTION

The following clearly describes the technical solutions in the embodiments of this application with reference to the accompanying drawings in the embodiments of this application. Clearly, the described embodiments are some but not all of the embodiments of this application. All other embodiments obtained by persons of ordinary skill in the art based on the embodiments of this application fall within the protection scope of this application.

The terms “first”, “second”, and the like in this specification and the claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not limit the number of objects. For example, there may be one or more first objects. In addition, in this specification and the claims, “and/or” indicates at least one of connected objects, and the character “/” generally indicates an “or” relationship between contextually associated objects.

It should be noted that technologies described in the embodiments of this application are not limited to a Long Term Evolution (LTE)/LTE-Advanced, (LTE-A) system, and may also be applied to other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application are often used interchangeably, and the technology described herein may be used in the aforementioned systems and radio technologies as well as other systems and radio technologies. In the following descriptions, a New Radio (NR) system is described for an illustration purpose, and NR terms are used in most of the following descriptions, but these technologies may also be applied to applications other than an NR system application, for example, a 6^{th} Generation (6G) communication system.

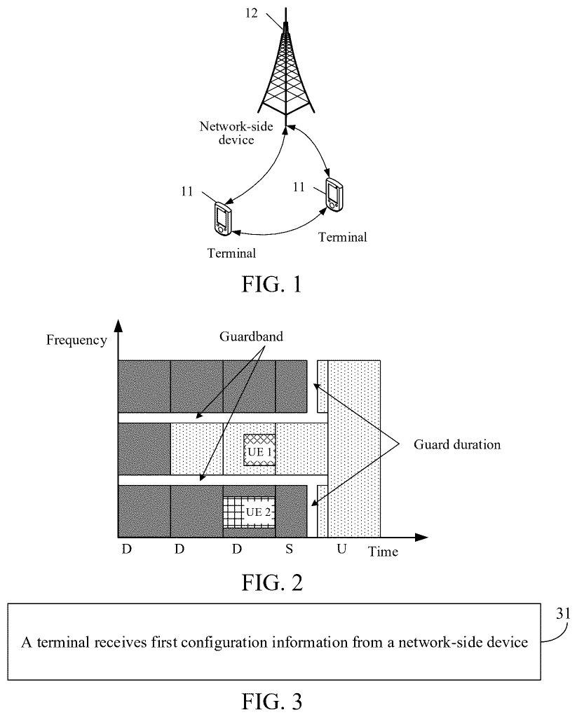

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet personal computer, a laptop computer or referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (a home appliance with a wireless communication function, for example, a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. Provided that the same technical effect is achieved, the base station is not limited to a specific technical term. It should be noted that the base station in the NR system is used only as an example for description in the embodiments of this application, but a specific type of the base station is not limited.

For ease of understanding the embodiments of this application, the following content is first described.

During deployment of a conventional cellular network, a Frequency Division Duplex (FDD) or Time Division Duplex (TDD) mode may be used based on a valid spectrum, service characteristics, and the like. In the FDD mode, uplink transmission and downlink transmission are performed at different frequencies, and uplink transmission and downlink transmission do not interfere with each other and can be simultaneously performed. In the TDD mode, uplink transmission and downlink transmission are performed at a same frequency, and are performed in a staggered manner through time division. The two duplex modes have respective advantages and disadvantages.

A flexible duplex mode is proposed, to more flexibly utilize limited spectrum resources, dynamically match service requirements, and improve resource utilization and data transmission performance such as an uplink coverage area and a delay. The flexible duplex mode may be referred to as a non-overlapping sub-band full duplex (SBFD) mode. The SBFD is as follows: network-side full duplex, where uplink transmission and downlink transmission can be simultaneously performed in different frequency domain positions at one moment, and to avoid interference between uplink and downlink, a guardband may be reserved between frequency domain positions (corresponding to a duplex sub-band) corresponding to different transmission directions; and terminal-side half duplex, which is consistent with time division duplex TDD, where only uplink transmission or downlink transmission can be performed at one moment, and uplink transmission and downlink transmission cannot be simultaneously performed. It can be understood that, in this duplex mode, uplink transmission and downlink transmission on a network side at one moment can only be directed at different terminals.

FIG. 2 is a schematic diagram of the flexible duplex mode. A network-side device semi-statically divides, in frequency domain, a single carrier into three duplex sub-bands within a part of downlink symbols. Downlink duplex sub-bands are on both sides of the carrier, and an uplink duplex sub-band is in the middle, to reduce interference to an adjacent carrier. In the 3^{rd} slot, UE 1 and UE 2 are used for uplink transmission and downlink reception respectively.

For example, when a cell (for example, an NR cell) is deployed on an asymmetric spectrum, the TDD mode is usually used. In this case, a TDD uplink/downlink common configuration TDD-UL-DL-ConfigCommon may be configured in a common parameter of the cell to indicate TDD frame structure information, including a TDD frame cycle, the number of full downlink/uplink slots included in a single frame cycle, the number of additional downlink/uplink symbols included other than the full downlink/uplink slots, and the like. For example, a TDD uplink/downlink dedicated configuration TDD-UL-DL-ConfigDedicated may be further configured for terminals by using Radio Resource Control (RRC) signaling, to further modify an uplink/downlink symbol configuration of one or more slots in a single frame cycle based on the TDD-UL-DL-ConfigCommon. To be specific, an initial value of an uplink/downlink symbol configuration of a slot is specified by the TDD-UL-DL-ConfigCommon and then further modified based on the TDD-UL-DL-ConfigDedicated. The modification applies only to a terminal that receives the RRC signaling. However, the modification herein is limited to further indicating a flexible symbol (Flexible symbol) in a slot as a Downlink symbol (DL symbol) or an Uplink symbol (UL symbol), without changing a DL/UL symbol in the slot to another direction. The flexible symbol is a symbol whose transmission direction is not specified. Whether the flexible symbol is used for downlink transmission or uplink transmission may be subsequently determined as needed.

The TDD-UL-DL-ConfigCommon and/or the TDD-UL-DL-ConfigDedicated are optional configurations. This configuration information can only be semi-statically configured/modified based on RRC signaling. Therefore, each symbol that is in a single TDD frame cycle and that is determined based on the configuration information, in combination with a transmission direction configured for the symbol, is referred to as a semi-static DL/UL/flexible symbol in the following descriptions. In addition, a symbol may be further abstracted into a time domain unit. The time domain unit may correspond to a slot, a symbol, or the like. In this case, a single TDD frame cycle may include a plurality of semi-static DL/UL/flexible time domain units based on the foregoing configuration information. If the TDD-UL-DL-ConfigCommon and the TDD-UL-DL-ConfigDedicated are not configured, there is no clear concept of TDD frame cycle. In this case, each slot/symbol in each radio frame of an NR cell may be understood as a semi-static flexible slot/symbol or abstracted into a semi-static flexible time domain unit.

In the embodiments of this application, for SRS parameter configuration, during configuration of an SRS resource for specific usage, an SRS resource is first configured, and then one or more SRS resources are organized into a single SRS resource set SRS Resource Set. During configuration of periodic SRS transmission, activation/deactivation of semi-persistent SRS transmission, or triggering of aperiodic SRS transmission, an SRS resource set is used as a unit. For a single SRS resource set, resource types of all SRS resources included in the SRS resource set need to be the same. In addition, a resource type of an SRS resource included in the SRS resource set is the same as a resource type of the SRS resource set. The resource type includes: periodic, semi-persistent, or aperiodic.

For example, usage of a single SRS resource set is one of the following four types:

(1) Codebook: used for codebook-based Physical Uplink Shared Channel (PUSCH) transmission. Based on an SRS resource indicator (SRI) indicator field in uplink scheduling Downlink Control Information (DCI), an antenna port configuration for scheduled PUSCH transmission is determined from a port configuration corresponding to a single SRS resource indicated in a single SRS resource set with usage set to ‘codebook’.

For example, for a single UL BWP/SRS Config of a single terminal, a network-side device configures at most a single SRS resource set with usage set to ‘codebook’.

(2) nonCodebook: used for noncodebook-based PUSCH transmission. Based on an SRI indicator field in uplink scheduling DCI, an antenna port configuration for scheduled PUSCH transmission is determined from an SRS resource combination/subset indicated in a single SRS resource set with usage set to ‘nonCodebook’. Each SRS resource in the SRS resource set can correspond only to a single SRS port. The SRS resource combination/subset includes one or more SRS resources in the SRS resource set.

For example, for a single UL BWP/SRS Config of a single terminal, a network-side device configures at most a single SRS resource set with usage set to ‘nonCodebook’.

(3) Beam management beamManagement: used for beam management. It can be understood that SRS resources in an SRS resource set correspond to different analog beams.

For example, for a single UL BWP/SRS Config of a single terminal, a network-side device may configure a plurality of SRS resource sets with usage set to ‘beamManagement’. Different SRS resource sets may be understood as corresponding to different antenna panels among a plurality of antenna panels that can simultaneously perform uplink SRS transmission with the terminal.

(4) Antenna switching antennaSwitching: used for DL CSI acquisition. This may be understood as follows: A terminal sends an SRS in uplink, and a network side measures the SRS signal and determines CSI of downlink data transmission based on channel reciprocity of a TDD system.

For example, the number of SRS resource sets that a network-side device can configure for a single UL BWP/SRS Config of a single terminal is determined based on an antenna configuration of the terminal, and the network-side device may configure a plurality of SRS resource sets with usage set to ‘antennaSwitching’. The plurality of SRS resource sets may respectively correspond to different values in a resource type dimension, a port dimension, or the like.

In the flexible duplex mode, valid uplink resources exist in both a downlink symbol and an uplink symbol of a TDD frame structure. However, the two types of uplink resources correspond to different valid bandwidth, and cause or are subject to different interference. For SRS transmission, parameters, such as a time domain/frequency domain/code domain parameter, a power-related parameter, and a spatial relation-related parameter, that match characteristics of the two types of uplink resources may be configured for the uplink resources, to fully utilize different uplink resources based on characteristics of the uplink resources, and ensure SRS transmission performance.

In the embodiments of this application, a semi-static flexible time domain unit is a semi-static flexible time domain unit in which a flexible duplex operation is allowed. An uplink resource usage limitation indicates that an uplink resource needs to be limited to a frequency domain range corresponding to a UL sub-band. With respect to whether an uplink resource usage limitation corresponding to an uplink sub-band (UL sub-band) exists in a semi-static flexible time domain unit, either of the following modes may be used:

Frequency domain limitation mode 1: There is a limitation. In the semi-static flexible time domain unit, only the frequency domain range corresponding to the UL sub-band is used as valid uplink resources.

Frequency domain limitation mode 2: There is no limitation. In the semi-static flexible time domain unit, all the frequency domain range corresponding to an uplink Bandwidth Part (BWP) can be used as valid uplink resources, without being limited to a frequency domain range corresponding to the UL sub-band.

A Synchronization Signal and PBCH block (SSB) time domain unit cannot be configured as a semi-static UL time domain unit or indicated as a dynamic UL time domain unit by a Slot Format Indicator (SFI). The time domain unit herein may be understood as a symbol, and the SSB time domain unit is, for example, an SSB symbol. In addition, a terminal does not send uplink transmission that overlaps with the SSB time domain unit. The uplink transmission may include at least one of the following: Physical Uplink Shared Channel (PUSCH) transmission, Physical Uplink Control Channel (PUCCH) transmission, Physical Random Access Channel (PRACH) transmission, Sounding Reference Signal (SRS) transmission, or the like. For example, for the PUSCH/PUCCH/PRACH transmission, when the PUSCH/PUCCH/PRACH transmission overlaps with at least one SSB time domain unit, the terminal does not send the PUSCH/PUCCH/PRACH transmission. For the SRS transmission, when the SRS transmission overlaps with at least one SSB time domain unit, the terminal does not send the SRS transmission in an SSB time domain unit in which the overlapping occurs.

In the flexible duplex mode, with respect to whether a flexible duplex operation or uplink transmission is allowed in an SSB time domain unit, either of the following modes may be used:

SSB collision limitation mode 1: The foregoing uplink transmission limitation is retained. To be specific, no flexible duplex operation is allowed in the SSB time domain unit, and the terminal does not send PUSCH/PUCCH/PRACH/SRS transmission that overlaps with the SSB time domain unit.

For example, if PUSCH/PUCCH/PRACH/SRS transmission does not overlap with the SSB time domain unit, but a spacing between the last time domain unit of an SSB time domain unit set and the 1^{st} time domain unit of the PUSCH/PUCCH/PRACH/SRS transmission is less than downlink-to-uplink switching time (referred to as downlink-uplink switching time for short), or a spacing between the last time domain unit of the PUSCH/PUCCH/PRACH/SRS transmission and the 1^{st} time domain unit of an SSB time domain unit set is less than the uplink-to-downlink switching time (referred to as the uplink-downlink switching time for short), the terminal does not send the PUSCH/PUCCH/PRACH/SRS transmission. The SSB time domain unit set may include one or more SSB time domain units that are continuous in time domain.

SSB collision limitation mode 2: The foregoing uplink transmission limitation is removed or partially removed. To be specific, a flexible duplex operation is allowed in the SSB time domain unit. In addition, when a flexible duplex operation is configured in the SSB time domain unit, the terminal is allowed to: when a predefined condition is met, send PUSCH/PUCCH/PRACH/SRS transmission that overlaps with the SSB time domain unit; or send PUSCH/PUCCH/PRACH/SRS transmission that does not overlap with the SSB time domain unit, where a spacing between the last time domain unit of the PUSCH/PUCCH/PRACH/SRS transmission and the 1st time domain unit of an SSB time domain unit set is less than uplink-downlink switching time; or send PUSCH/PUCCH/PRACH/SRS transmission that does not overlap with the SSB time domain unit, where a spacing between the 1st time domain unit of the PUSCH/PUCCH/PRACH/SRS transmission and the last time domain unit of an SSB time domain unit set is less than downlink-uplink switching time.

For example, the predefined condition may include at least one of the following:
(1) a frequency domain resource occupied by the PUSCH/PUCCH/PRACH/SRS transmission does not overlap with an SSB frequency domain resource;
(2) a frequency domain resource occupied by the PUSCH/PUCCH/PRACH/SRS transmission is limited to a frequency domain range of a UL sub-band configured in the SSB time domain unit;
(3) the PUSCH/PUCCH/PRACH/SRS transmission is transmission scheduled based on dynamic signaling; or
(4) a priority of the PUSCH/PUCCH transmission is a high priority, for example, is configured or indicated as 1.

For example, when an SSB is transmitted in a semi-static UL time domain unit or in a dynamic UL time domain unit indicated by Downlink Control Information (DCI) (for example, a DCI format 2_0), the SSB collision limitation mode 2 may also be used for a time domain unit in which the SSB transmission is performed.

The following describes in detail an information configuration method and apparatus, a terminal, a network-side device, and a readable storage medium provided in the embodiments of this application with reference to the accompanying drawings and by using some embodiments and application scenarios thereof.

FIG. 3 is a flowchart of an information configuration method according to an embodiment of this application. The method is applied to a terminal. As shown in FIG. 3, the method includes the following steps.

Step 31: The terminal receives first configuration information from a network-side device.

In this embodiment, in the first configuration information, a maximum of M sets of configuration information are configured for a single SRS resource, each set of configuration information corresponds to a time domain unit meeting a specific requirements, and Mis an integer greater than 1; and/or the first configuration information is used for configuring a first object, the first object, after being configured, corresponds to a time domain unit meeting a specific requirement, and the first object includes at least one of the following: at least two SRS resource sets or at least two SRS configurations (for example, SRS Config).

It should be noted that the configuration information may be understood as including at least related configuration information in a parameter structure SRS-Resource, including time domain resource information, frequency domain resource information, code domain resource information, space domain information, and the like. The time domain resource information includes a starting symbol index startPosition, the number of occupied symbols nrofSymbols, a repetition factor repetitionFactor, and the like. The frequency domain resource information includes a frequency domain shift freqDomainShift, a frequency domain starting position freqDomainPosition, a frequency hopping parameter c-SRS/b-SRS/b-hop, and the like. The code domain resource information includes transmission comb-related configurations combOffset/cyclicShift and the like. The space domain information includes a spatial relation SRS-SpatialRelationInfo and the like. For example, the configuration information may further include power configuration information and the like. For example, some basic configuration parameters, including a resource ID srs-ResourceId, the number of SRS ports nrofSRS-Ports, and a resource type resourceType, and the like, may be uniformly configured for each SRS resource, in other words, only one set of parameters is configured, without distinguishing between types of time domain units during configuration.

In the information configuration method in this embodiment of this application, for SRS transmission, parameters, such as a time domain/frequency domain/code domain parameter, a power-related parameter, and a spatial relation-related parameter, that match characteristics of different uplink resources may be configured for the uplink resources by using the first configuration information. In this way, different uplink resources are fully utilized based on characteristics of the uplink resources, to ensure SRS transmission performance.

For example, in a flexible duplex mode, for two types of uplink resources on an SBFD carrier, different solutions may be introduced for configuring SRS parameters for the uplink resources and performing corresponding SRS transmission. In this way, different uplink resources can be fully utilized based on characteristics of the uplink resources, and SRS transmission performance is ensured.

For example, the time domain unit meeting the specific requirement may include a first type of time domain units and/or a second type of time domain units, the first type of time domain units is any time domain unit with a valid uplink resource in an uplink BWP range, and the second type of time domain units is any time domain unit with a valid uplink resource only in an uplink sub-band range.

It should be noted that, in this embodiment of this application, two types of time domain units, such as the first type of time domain units and the second type of time domain units, are used as an example for description. However, these descriptions may be further extended to a case with more than two types of time domain units as needed. In this case, the time domain unit may be correspondingly adjusted to a type-A time domain unit. In this embodiment of this application, a time domain unit of another type below is time domain units of all types other than a time domain unit of a predefined type/a time domain unit of a specified type, or is a time domain unit of any type other than a time domain unit of a predefined type/a time domain unit of a specified type.

For example, the first type of time domain units may include at least one of the following:
(1) A semi-static uplink time domain unit.
(2) A first semi-static flexible time domain unit. In the first semi-static flexible time domain unit, all the frequency domain range corresponding to an uplink BWP can be used as valid uplink resources. In other words, the frequency domain limitation mode 2 is used. The first semi-static flexible time domain unit is a semi-static flexible time domain unit in which a flexible duplex operation is allowed.

It can be understood that the first semi-static flexible time domain unit herein does not include an SSB time domain unit in the SSB collision limitation mode 1.

For example, the second type of time domain units may include at least one of the following:

(1) A semi-static downlink time domain unit. The semi-static downlink time domain unit herein may be understood as a semi-static DL time domain unit configured to have a UL sub-band.

It can be understood that the semi-static DL time domain unit herein does not include an SSB time domain unit in the SSB collision limitation mode 1.

(2) A second semi-static flexible time domain unit. In the second semi-static flexible time domain unit, only the frequency domain range corresponding to an uplink sub-band can be used as valid uplink resources. In other words, the frequency domain limitation mode 1 is used. The second semi-static flexible time domain unit is a semi-static flexible time domain unit in which a flexible duplex operation is allowed.

It can be understood that the second semi-static flexible time domain unit herein does not include SSB time domain unit in the SSB collision limitation mode 1.

In this embodiment of this application, SRS parameter configurations and SRS transmission for different usage may be configured in different manners, which are described below.

### Configuration Manner 1

In this configuration manner, if usage of an SRS resource set is codebook/nonCodebook, a limitation indicating to configure only a single SRS resource set is still used.

For example, SRS parameters may be configured in any one of the following manners.

Manner 0: For periodic/semi-persistent SRS transmission, different parameter values are configured for different SRS resources in an SRS resource set to respectively match/correspond to the first type of time domain units and the second type of time domain units.

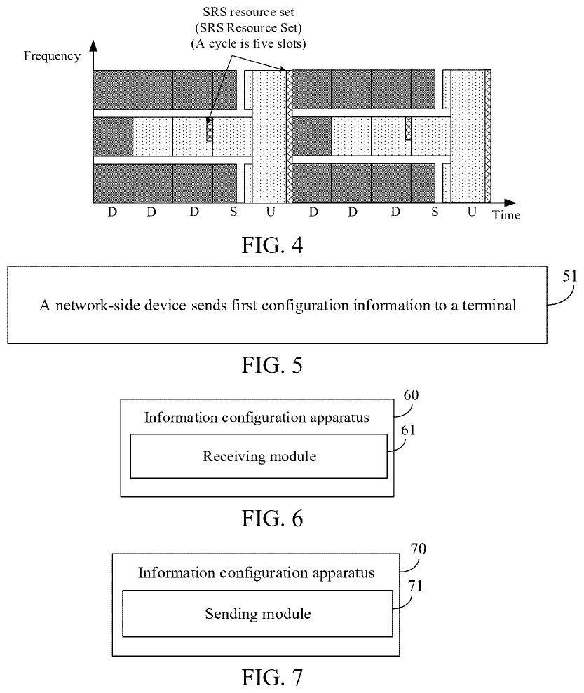

For example, an implementation-based manner may be used when a cycle of the SRS resource set (which is consistent with cycles of SRS resources in the SRS resource set) is an integer multiple of a length of a TDD pattern. As shown in FIG. 4, offsets and frequency domain parameters (for example, a frequency domain shift freqDomainShift, a frequency domain starting position freqDomainPosition, and frequency hopping parameters c-SRS/b-SRS/b-hop) of SRS resources in the SRS resource set may be configured to different values, to respectively correspond to the first type of time domain units (for example, a UL slot) and the second type of time domain units (for example, an SBFD slot) based on a network-side implementation such as a configuration algorithm. Herein, it is assumed that a power control configuration, an antenna configuration, a spatial relation configuration, and the like do not need to be separately configured for the first type of time domain units and the second type of time domain units. In other words, the first type of time domain units and the second type of time domain units may share a same set of parameter configurations for SRS resources. It can be understood that, in the SRS resource set, an SRS resource subset corresponding to the first type of time domain units and an SRS resource subset corresponding to the second type of time domain units may be determined based on the network-side implementation as needed.

It should be noted that, to ensure that consistency between the maximum number of SRS resources corresponding to a specify type of time domain unit and an existing protocol (for example, to ensure consistent beam selection capabilities), the maximum number of SRS resources in the SRS resource set needs to be increased correspondingly. The specific number of SRS resources after the increase depends on at least one of the number of time domain unit types or the number of UL sub-bands. For example, the maximum number is increased to be twice that specified in the existing protocol: \textcircled{1} When usage is codebook, the maximum number is increased as follows: 2×2=4. \textcircled{2}When usage is nonCodebook, the maximum number is increased as follows: 4×2=8.

For another example, when the cycle of the SRS resource set is less than the length of the TDD pattern or is not an integer multiple of the length of the TDD pattern, correspondences between different SRS resources and different time domain unit types may not be implemented. In this case, the following manner 1 or manner 2 may be used.

Manner 1: A maximum of M sets of configuration information are configured for a single SRS resource. Each set of configuration information corresponds to/applies only to the first type of time domain units or the second type of time domain units.

For example, the network-side device may configure a single set of configuration information or two sets of configuration information for a single SRS resource. If two sets of configuration information are configured for a single SRS resource and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units. If only a single set of configuration information is configured for a single SRS resource, for example, if only the first set of configuration information or the second set of configuration information is configured, the single set of configuration information corresponds to the first type of time domain units or the second type of time domain units. The numbers of sets of configuration information configured for different SRS resources may be the same or different. When only a single set of configuration information is configured for each SRS resource among more than one SRS resource, only the first set of configuration information or the second set of configuration information may be configured for these SRS resources; or only the first set of configuration information is configured for at least one SRS resource, and only the second set of configuration information is configured for other SRS resources. For example, configuration statuses of configuration information for all SRS resources in a single SRS resource set need to be the same. For example, two sets of configuration information are configured for each SRS resource, or a single set of configuration information is configured for each SRS resource. When a single set of configuration information is configured for each SRS resource, the first set of configuration information or the second set of configuration information is configured for each SRS resource.

Based on configuration information configured for a single SRS resource, corresponding processing may be performed in the following cases.

Case 1-1: Only a single set of configuration information is configured for a single SRS resource. For example, only the first set of configuration information or the second set of configuration information is configured.

In this case, the single set of configuration information configured may correspond to/apply to a time domain unit of a predefined type by default. For example, when only the first set of configuration information is configured, the time domain unit of the predefined type may be the first type of time domain units; or when only the second set of configuration information is configured, the time domain unit of the predefined type may be the second type of time domain units. For example, when only a single set of configuration information is configured, the time domain unit of the predefined type is always the first type of time domain units or the second type of time domain units. This may be specified in a protocol or configured by using higher layer signaling or the like. It is assumed that, when the time domain unit of the predefined type is the first type of time domain units, a time domain unit of another type is the second type of time domain units; or when the time domain unit of the predefined type is the second type of time domain units, a time domain unit of another type is the first type of time domain units.

In this case, the terminal may determine an invalid resource/invalid transmission in any one of the following manners.

(1) If a time domain unit (for example, corresponding to nrofSymbols symbols) occupied by a first SRS resource in a first slot (for example, a specific slot) overlaps with a time domain unit of another type based on second configuration information, the terminal may perform one of the following:
Determine that the first SRS resource is invalid/unavailable in the first slot. In this case, the terminal does not initiate corresponding SRS transmission, and the time domain unit of the another type is considered as an invalid time domain unit.
When a first predefined condition is not met in at least one overlapping time domain unit of the another type (to be specific, at least one time domain unit among occupied time domain units of the another type), determine that the first SRS resource is invalid/unavailable in the first slot. In this case, the terminal does not initiate corresponding SRS transmission, and when the first predefined condition is met, the time domain unit of the another type is considered as a valid time domain unit; or otherwise, the time domain unit of the another type is considered as an invalid time domain unit.

(2) If a time domain unit (for example, corresponding to repetitionFactor symbols among nrofSymbols symbols) occupied by a second transmission on a first SRS resource in a second slot (for example, a specific slot) overlaps with a time domain unit of another type based on second configuration information, where the second transmission may be any transmission on the first SRS resource in the second slot, the terminal may perform one of the following:
Determine that the second transmission is invalid/unavailable in the second slot. In this case, the terminal does not initiate corresponding SRS transmission, and the time domain unit of the another type is considered as an invalid time domain unit.
When a first predefined condition is not met in at least one overlapping time domain unit of the another type (to be specific, at least one time domain unit among occupied time domain units of the another type), determine that the second transmission is invalid/unavailable in the second slot. In this case, the terminal does not initiate corresponding SRS transmission, and when the first predefined condition is met, the time domain unit of the another type is considered as a valid time domain unit; or otherwise, the time domain unit of the another type is considered as an invalid time domain unit.

(3) If all time domain units (for example, corresponding to nrofSymbols symbols) occupied by a first SRS resource in a third slot (for example, a specific slot) are time domain units of another type based on second configuration information, the terminal may perform one of the following:
Determine that the first SRS resource is invalid/unavailable in the third slot. In this case, the terminal does not initiate corresponding SRS transmission, and all the time domain units of another type are considered as invalid time domain units.
When a first predefined condition is met in none of the occupied time domain units of the another type (to be specific, all of the occupied time domain units of the another type), determine that the first SRS resource is invalid/unavailable in the third slot. In this case, the terminal does not initiate corresponding SRS transmission, and when the first predefined condition is met, the time domain units of the another type are considered as valid time domain units; or otherwise, the time domain units of the another type are considered as invalid time domain units.

(4) If all time domain units (for example, corresponding to repetitionFactor symbols among nrofSymbols symbols) occupied by third transmission on a first SRS resource in a fourth slot (for example, a specific slot) are time domain units of another type based on second configuration information, where the third transmission may be any transmission on the first SRS resource in the fourth slot, the terminal may perform one of the following:
Determine that the third transmission is invalid/unavailable in the fourth slot. In this case, the terminal does not initiate corresponding SRS transmission, and all the time domain units of another type are considered as invalid time domain units.
When a first predefined condition is met in none of the occupied time domain units of the another type (to be specific, all of the occupied time domain units of the another type), determine that the third transmission is invalid/unavailable in the fourth slot. In this case, the terminal does not initiate corresponding SRS transmission, and when the first predefined condition is met, the time domain units of the another type are considered as valid time domain units; or otherwise, the time domain units of the another type are considered as invalid time domain units.

The second configuration information is a single set of configuration information configured for the first SRS resource. The first SRS resource is a single SRS resource in the SRS resource set. A type of a time domain unit corresponding to the second configuration information is different from a type of the time domain unit of the another type. For example, the time domain unit corresponding to the second configuration information is the first type of time domain units, and the time domain unit of the another type is the second type of time domain units; or the time domain unit corresponding to the second configuration information is the second type of time domain units, and the time domain unit of the another type is the first type of time domain units.

It should be noted that the overlapping may be understood as that at least one of time domain units occupied by the first SRS resource/the second transmission is the time domain unit of the another type. A predefined method may be used for processing a collision between a time domain unit occupied by the first SRS resource in a specific slot or a time domain unit occupied by specific transmission in a specific slot based on a single set of configuration information configured and a time domain unit (for example, a semi-static DL time domain unit not configured with a UL sub-band, and/or a semi-static flexible time domain unit in which no flexible duplex operation is allowed) other than the first-type/second type of time domain units in this application. For example, if specific SRS transmission corresponding to the first SRS resource overlaps with at least one semi-static DL time domain unit (to be specific, a time domain unit configured for downlink by using higher layer signaling TDD-UL-DL-ConfigCommon and/or TDD-UL-DL-ConfigDedicated, regardless of whether an uplink sub-band is configured in the time domain unit) and/or an SSB time domain unit (to be specific, at least one of time domain units occupied by the SRS transmission is the semi-static DL time domain unit and/or the SSB time domain unit), the SRS transmission is not performed in any overlapping time domain unit.

It can be understood that, in (3) and (4), if at least one of time domain units occupied by the first SRS resource or the transmission on the first SRS resource in the slot is not a time domain unit of another type, and at least one of the time domain unit(s) not of another type is not subject to a collision based on a predefined method and allows SRS transmission, where for the predefined method, reference may be made to the foregoing descriptions, it can be considered that the first SRS resource or the transmission on the first SRS resource is valid or available in this slot. Therefore, the terminal may perform sending for the first SRS resource or the transmission on the first SRS resource in at least the time domain unit in which SRS transmission is allowed.

In (3) and (4), if at least one of time domain units occupied by the first SRS resource or the transmission on the first SRS resource in the slot is not a time domain unit of another type, or if an occupied time domain unit is a time domain unit of another type but the first predefined condition is met in the time domain unit (it is assumed that the time domain unit is a valid time domain unit), and at least one of the valid time domain unit(s) is not subject to a collision based on a predefined method and allows SRS transmission, where for the predefined method, reference may be made to the foregoing descriptions, it can be considered that the first SRS resource or the transmission on the first SRS resource is valid or available in this slot. Therefore, the terminal may perform sending for the first SRS resource or the transmission on the first SRS resource in at least the time domain unit in which SRS transmission is allowed.

For example, the first predefined condition may include at least one of the following:
(i) A frequency domain range corresponding to all Physical Resource Block (PRB) at a first layer/top layer in a frequency domain hierarchical structure of the first SRS resource is within a frequency domain range corresponding to an uplink sub-band. For example, the frequency domain hierarchical structure may be determined based on a frequency domain shift freqDomainShift and a frequency hopping parameter c-SRS. The first layer/top layer in the frequency domain hierarchical structure may correspond to m_{SRS,0} PRBs of a layer with B_{SRS}=0.
(ii) a frequency domain range corresponding to all PRBs at a frequency hopping layer in a frequency domain hierarchical structure of the first SRS resource is within a frequency domain range corresponding to an uplink sub-band. For example, the frequency domain hierarchical structure may be determined based on a frequency domain shift freqDomainShift and a frequency hopping parameter c-SRS, and the frequency hopping layer may be determined based on a frequency hopping parameter b-hop (namely, bₕₒₚ) and the frequency domain shift freqDomainPosition. The frequency hopping layer in the frequency domain hierarchical structure may correspond to m_{SRS,b}_{ₕₒₚ} PRBs.
(iii) A union of frequency domain ranges corresponding to one or more SRS transmissions expected to occur for the first SRS resource in a corresponding slot is within a frequency domain range corresponding to an uplink sub-band.
(iv) A frequency domain range corresponding to a corresponding transmission for the first SRS resource in a corresponding slot is within a frequency domain range corresponding to an uplink sub-band.

Case 1-2: Two sets of configuration information are configured for a single SRS resource. For example, the first set of configuration information and the second set of configuration information are configured.

In this case, for a single SRS resource (for example, corresponding to nrofSymbols symbols) or first transmission (for example, specific transmission corresponding to repetitionFactor symbols among the nrofSymbols symbols) on the SRS resource, the terminal may determine, based on at least one of the following, applied configuration information from the two sets of configuration information configured:

(1) A type of a time domain unit in which the SRS resource is located, or a type of a time domain unit in which the first transmission on the SRS resource is located. To be specific, applied configuration information may be determined based on a type of a time domain unit in which the SRS resource or specific transmission on the SRS resource is located.

For example, when the time domain unit in which the SRS resource or the specific transmission on the SRS resource is located is the first type of time domain units, the first set of configuration information configured for the SRS resource is applied; or when the time domain unit in which the SRS resource or the specific transmission on the SRS resource is located is the second type of time domain units, the second set of configuration information configured for the SRS resource is applied. For example, a mapping relationship between a time domain unit type and configuration information may be specified in a protocol or configured by using higher layer signaling or the like.

(2) First higher layer signaling. To be specific, applied configuration information is configured by using higher layer signaling.

For example, applied configuration information is uniformly configured for the terminal, serving cells configured with SRS transmission, UL BWPs configured with SRS transmission, or SRS Configs; or applied configuration information is separately configured for various types of usage of SRS transmission corresponding to a specific SRS Config; or applied configuration information is separately configured for each SRS resource set; or applied configuration information is separately configured for each SRS resource included in a specific SRS resource set.

(3) First DCI. To be specific, applied configuration information is determined based on DCI.

In (3), a specific set of configuration information to be applied is determined based on DCI that triggers transmission for an SRS resource set. The DCI that triggers transmission for the SRS resource set includes, for example, a DCI format 1_1, a DCI format 1_2, a DCI format 0_1, a DCI format 0_2, and a DCI format 2_3. It can be understood that this manner applies only to an SRS resource set/SRS resource whose resource type (resourceType) is aperiodic.

For example, when the applied configuration information is determined based on the first DCI, the applied configuration information may be implicitly determined or explicitly indicated in either of the following manners.

\textcircled{1} The applied configuration information is implicitly determined.

For example, the applied configuration information corresponds to a type of a time domain unit in which an SRS resource triggered by the first DCI is located. For example, a time domain unit corresponding to each SRS resource in a triggered SRS resource set/in which each SRS resource in a triggered SRS resource set is located may be determined based on a time domain unit in which triggering DCI is located (for example, a slot in which the triggering DCI is located) and a slotOffset parameter. Based on a type of a time domain unit to which/in which an SRS resource corresponds/is located, configuration information corresponding to the type may be applied.

\textcircled{2} The applied configuration information is explicitly indicated.

For example, a specific set of configuration information to be applied may be explicitly indicated by an indicator field in triggering DCI. The applied configuration information may meet any one of the following:
The applied configuration information is indicated by a first indicator field in the first DCI. For example, an independent indicator field in the first DCI may indicate a specific set of configuration information to be uniformly applied to one or more triggered SRS resource sets, or a specific set of configuration information to be separately applied to each triggered SRS resource set, or a specific set of configuration information to be separately applied to each SRS resource in each triggered SRS resource set. Existence of the first indicator field in the first DCI may be configured by using higher layer signaling. When the first indicator field does not exist, default configuration information (for example, the first set of configuration information) is applied. When the first indicator field exists, the number of corresponding bits is determined based on the foregoing indication manner and a value of M.

An SRS request and applied configuration information are jointly indicated by a second indicator field in the first DCI. For example, joint coding may be performed with an SRS request indicator field. A codepoint in a joint indicator field (the number of bits occupied by this field may be increased as needed relative to the number of bits occupied by the SRS request indicator field) indicates both a triggered SRS resource set and applied configuration information.

It should be noted that, in (2) and (3), the terminal always uses configured/indicated configuration information for an SRS resource.

It is assumed that a single set of configured/indicated configuration information corresponds to/applies to a time domain unit of a specified type. For example, when the first set of configuration information is to be applied as configured/indicated, the time domain unit of the specified type is the first type of time domain units; or when the second set of configuration information is to be applied as configured/indicated, the time domain unit of the specified type is the second type of time domain units. For example, a mapping relationship between a time domain unit type and configuration information may be specified in a protocol or configured by using higher layer signaling or the like. It is assumed that, when the time domain unit of the specified type is the first type of time domain units, a time domain unit of another type is the second type of time domain units; or when the time domain unit of the specified type is the second type of time domain units, a time domain unit of another type is the first type of time domain units.

For example, if two sets of configuration information are configured for a single SRS resource, the terminal may determine an invalid resource/invalid transmission in the following manners.

(1) If a time domain unit (for example, corresponding to nrofSymbols symbols) occupied by a first SRS resource in a first slot (for example, a specific slot) overlaps with a time domain unit of another type based on second configuration information, the terminal may perform one of the following:
Determine that the first SRS resource is invalid/unavailable in the first slot. In this case, the terminal does not initiate corresponding SRS transmission, and the time domain unit of the another type is considered as an invalid time domain unit.
When a first predefined condition is not met in at least one overlapping time domain unit of the another type (to be specific, at least one time domain unit among occupied time domain units of the another type), determine that the first SRS resource is invalid/unavailable in the first slot. In this case, the terminal does not initiate corresponding SRS transmission, and when the first predefined condition is met, the time domain unit of the another type is considered as a valid time domain unit; or otherwise, the time domain unit of the another type is considered as an invalid time domain unit.

(2) If a time domain unit (for example, corresponding to repetitionFactor symbols among nrofSymbols symbols) occupied by a second transmission on a first SRS resource in a second slot (for example, a specific slot) overlaps with a time domain unit of another type based on second configuration information, the terminal may perform one of the following:
Determine that the second transmission is invalid/unavailable in the second slot. In this case, the terminal does not initiate corresponding SRS transmission, and the time domain unit of the another type is considered as an invalid time domain unit.
When a first predefined condition is not met in at least one overlapping time domain unit of the another type (to be specific, at least one time domain unit among occupied time domain units of the another type), determine that the second transmission is invalid/unavailable in the second slot. In this case, the terminal does not initiate corresponding SRS transmission, and when the first predefined condition is met, the time domain unit of the another type is considered as a valid time domain unit; or otherwise, the time domain unit of the another type is considered as an invalid time domain unit.

(3) If all time domain units (for example, corresponding to nrofSymbols symbols) occupied by a first SRS resource in a third slot (for example, a specific slot) are time domain units of another type based on second configuration information, the terminal may perform one of the following:
Determine that the first SRS resource is invalid/unavailable in the third slot. In this case, the terminal does not initiate corresponding SRS transmission, and all the time domain units of another type are considered as invalid time domain units.
When a first predefined condition is met in none of the occupied time domain units of the another type (to be specific, all of the occupied time domain units of the another type), determine that the first SRS resource is invalid/unavailable in the third slot. In this case, the terminal does not initiate corresponding SRS transmission, and when the first predefined condition is met, the time domain units of the another type are considered as valid time domain units; or otherwise, the time domain units of the another type are considered as invalid time domain units.

(4) If all time domain units (for example, corresponding to repetitionFactor symbols among nrofSymbols symbols) occupied by third transmission on a first SRS resource in a fourth slot (for example, a specific slot) are time domain units of another type based on second configuration information, the terminal may perform one of the following:
Determine that the third transmission is invalid/unavailable in the fourth slot. In this case, the terminal does not initiate corresponding SRS transmission, and all the time domain units of another type are considered as invalid time domain units.
When a first predefined condition is met in none of the occupied time domain units of the another type (to be specific, all of the occupied time domain units of the another type), determine that the third transmission is invalid/unavailable in the fourth slot. In this case, the terminal does not initiate corresponding SRS transmission, and when the first predefined condition is met, the time domain units of the another type are considered as valid time domain units; or otherwise, the time domain units of the another type are considered as invalid time domain units.

The second configuration information is a set of configuration information determined from the two sets of configuration information configured for the first SRS resource. For example, the set of configuration information may be determined in any one of the manners (1), (2), and (3). The first SRS resource is a single SRS resource in the SRS resource set. A type of a time domain unit corresponding to the second configuration information is different from a type of the time domain unit of the another type. For example, the time domain unit corresponding to the second configuration information is the first type of time domain units, and the time domain unit of the another type is the second type of time domain units; or a time domain unit occupied by the first SRS resource is the second type of time domain units, and the time domain unit of the another type is the first type of time domain units.

It should be noted that the overlapping may be understood as that at least one of time domain units occupied by the first SRS resource/the second transmission is the time domain unit of the another type. A predefined method may be used for processing a collision between a time domain unit occupied by the first SRS resource in a specific slot or a time domain unit occupied by specific transmission in a specific slot based on the set of configuration information determined and a time domain unit (for example, a semi-static DL time domain unit not configured with a UL sub-band, and/or a semi-static flexible time domain unit in which no flexible duplex operation is allowed) other than the first-type/second type of time domain units in this application. For the predefined method, refer to the foregoing descriptions.

It can be understood that, in (1) to (4), whether to determine an invalid resources/invalid transmission based on the first predefined condition may be specified in a protocol; or may be uniformly configured for the terminal, serving cells configured with SRS transmission, UL BWPs configured with SRS transmission, or SRS Configs, or separately configured for various types of usage of SRS transmission corresponding to a specific SRS Config, or separately configured for each SRS resource set, or separately configured for each SRS resource included in a specific SRS resource set.

For example, if only a single set of configuration information is configured for a first SRS resource and the single set of configuration information is used as applied configuration information, or if two sets of configuration information are configured for a first SRS resource and one set of configuration information is determined from the two sets of configuration information as applied configuration information based on a configuration or an indication, when an SRS transmission corresponding to the first SRS resource is determined by using the applied configuration information, the terminal may perform one of the following:
not expecting that the first SRS resource overlaps with a time domain unit of another type in any slot (for example, corresponding to a plurality of slots when resourceType is periodic/semi-persistent, or corresponding to a single slot when resourceType is aperiodic) for transmission, or not expecting that the first SRS resource does not meet a first predefined condition in at least one overlapping time domain unit of another type, when overlapping exists, in any slot for transmission;
not expecting that any SRS transmission corresponding to the first SRS resource overlaps with a time domain unit of another type, or not expecting that any SRS transmission corresponding to the first SRS resource does not meet a first predefined condition in at least one overlapping time domain unit of another type when overlapping exists;
not expecting that all time domain units occupied by the first SRS resource in any slot for transmission are time domain units of another type, or not expecting that all time domain units occupied by the first SRS resource in any slot for transmission are time domain units of another type, and that the first SRS resource does not meet a first predefined condition in each occupied time domain unit of another type; or
not expecting that all time domain units occupied by any SRS transmission corresponding to the first SRS resource are time domain units of another type, or not expecting that all time domain units occupied by any SRS transmission corresponding to the first SRS resource are time domain units of another type, and that any SRS transmission corresponding to the first SRS resource does not meet a first predefined condition in each occupied time domain unit of the another type.

A type of a time domain unit corresponding to the applied configuration information is different from a type of the time domain unit of the another type. For example, the time domain unit corresponding to the applied configuration information is the first type of time domain units, and the time domain unit of the another type is the second type of time domain units; or the time domain unit corresponding to the applied configuration information is the second type of time domain units, and the time domain unit of the another type is the first type of time domain units.

For example, the first predefined condition may include at least one of the following:
(i) A frequency domain range corresponding to all Physical Resource Block (PRB) at a first layer/top layer in a frequency domain hierarchical structure of the first SRS resource is within a frequency domain range corresponding to an uplink sub-band. For example, the frequency domain hierarchical structure may be determined based on a frequency domain shift freqDomainShift and a frequency hopping parameter c-SRS. The first layer/top layer in the frequency domain hierarchical structure may correspond to m_{SRS,0} PRBs of a layer with B_{SRS}=0.
(ii) a frequency domain range corresponding to all PRBs at a frequency hopping layer in a frequency domain hierarchical structure of the first SRS resource is within a frequency domain range corresponding to an uplink sub-band. For example, the frequency domain hierarchical structure may be determined based on a frequency domain shift freqDomainShift and a frequency hopping parameter c-SRS, and the frequency hopping layer may be determined based on a frequency hopping parameter b-hop (namely, bₕₒₚ) and the frequency domain shift freqDomainPosition. The frequency hopping layer in the frequency domain hierarchical structure may correspond to m_{SRS,b}_{ₕₒₚ} PRBs.
(iii) A union of frequency domain ranges corresponding to one or more SRS transmissions expected to occur for the first SRS resource in a corresponding slot is within a frequency domain range corresponding to an uplink sub-band.
(iv) A frequency domain range corresponding to a corresponding transmission for the first SRS resource in a corresponding slot is within a frequency domain range corresponding to an uplink sub-band.

For example, in the case 1-1 or the case 1-2, for periodic/semi-static SRS transmission, to avoid a problem that some SRS sub-bands may not be traversed when frequency-hopping SRS transmission is configured, at least one of the following manners may be used: SRS transmission occasions (SRS Transmission Occasion) at which SRS transmission cannot be performed due to distinguishing between the first type of time domain units and the second type of time domain units are not counted.

Case 1: If only a single set of configuration information is applied to SRS transmissions corresponding to a second SRS resource, for each SRS transmission occasion in which the corresponding SRS transmission cannot be performed, the terminal performs a plus-one operation on a first counter, where the first counter is used for counting SRS transmission occasions in which the SRS transmissions cannot be performed.

This case 1 may correspond to the case 1-1 in which only a single set of configuration information is configured, and correspond to the case 1-2 in which a single set of applied configuration information is determined based on (2) or (3).

This case 1 may be understood as that a first counter n_offset_{SRS,other} is introduced, with an initial value of 0. When an invalid resource/invalid transmission is determined in (1) to (4), for each SRS transmission occasion at which SRS transmission cannot be performed due to a collision with another type of time domain unit that is an invalid time domain unit, n_offset_{SRS,other} is increased by 1. In this case, an SRS transmission counter n_{SRS}, for controlling frequency-hopping SRS transmission may be modified based on n_offset_{SRS,other}, as shown in the following formula:

$$Formula 1$$

$${n}_{SRS} = ( \frac{{N}_{slot}^{frame , μ} {n}_{f} + {n}_{s , f}^{μ} - {T}_{offset}}{{T}_{SRS}} - {n\_offset}_{SRS , other} ) \cdot ( \frac{{N}_{symb}^{SRS}}{R} ) + ⌊ {l}^{′} / R ⌋$$

In the formula 1, SRS transmission occurs only in a slot that meets (Nₛₗₒₜ^{frame,μ}n_{f}+n_{s,f}^{μ}−T_{offset})modT_{SRS}=0. n_{SRS} is used for counting SRS transmissions in the slot, and mod is a modulo symbol. T_{SRS} is a cycle of SRS transmission, measured in a unit of, for example, slot. T_{offset} is an offset of SRS transmission, measured in a unit of, for example, slot. l′∈{0, 1, . . . , N_{symb}^{SRS}−1} is a local symbol index in an SRS resource. Nₛₗₒₜ^{frame,μ} is the number of slots included in a single radio frame. n_{f} is a radio frame number of a radio frame in which the SRS transmission is located. n_{s,f}^{μ} is a slot number of a slot, in a radio frame n_{f}, in which SRS transmission is located. N_{symb}^{SRS} is the number of symbols nrofSymbols corresponding to the SRS resource. R is a repetition factor repetitionFactor configured for the SRS resource. └ ┘ indicates rounding down.

Case 2: If two sets of configuration information are applied to SRS transmission corresponding to a third SRS resource, when an SRS transmission corresponding to the third SRS resource is performed or partially performed once in the first type of time domain units, performing, by the terminal, a plus-one operation on a second counter, and when an SRS transmission corresponding to the third SRS resource is performed or partially performed once in the second type of time domain units, the terminal performs a plus-one operation on a third counter, where the second counter is used for counting SRS transmissions in the first type of time domain units, and the third counter is used for counting SRS transmissions in the second type of time domain units.

This case 2 may correspond to the case 1-2 in which a single set of applied configuration information is determined based on (1).

This case 2 may be understood as that a second counter n_offset_{SRS,UL} and a third counter n_offset_{SRS,SBFD} are introduced for SRS transmission on an SRS resource in the first type of time domain units and the second type of time domain units respectively, with an initial value of 0. When SRS transmission corresponding to the SRS resource is performed or partially performed once in the first type of time domain units, the second counter n_offset_{SRS,UL} is increased by 1. When SRS transmission corresponding to the SRS resource is performed or partially performed once in the second type of time domain units, the third counter n_offset_{SRS,SBFD} is increased by 1. It can be understood that, in a typical case, single SRS transmission does not simultaneously occupy the first type of time domain units and the second type of time domain units.

When SRS transmission corresponding to the SRS resource is performed or partially performed in the first type of time domain units, the SRS transmission counter n_{SRS,UL} may be modified based on the third counter n_offset_{SRS,SBFD}, as shown in the following formula:

$$Formula 2$$

$${n}_{SRS , UL} = ( \frac{{N}_{slot}^{frame , μ} {n}_{f} + {n}_{s , f}^{μ} - {T}_{offset}}{{T}_{SRS}} - {n\_offset}_{SRS , SBFD} ) \cdot ( \frac{{N}_{symb}^{SRS}}{R} ) + ⌊ {l}^{′} / R ⌋$$

When SRS transmission corresponding to the SRS resource is performed or partially performed in the second type of time domain units, the SRS transmission counter n_{SRS,SBFD} may be modified based on the second counter n_offset_{SRS,UL}, as shown in the following formula:

$$Formula 3$$

$${n}_{SRS , SBFD} = ( \frac{{N}_{slot}^{frame , μ} {n}_{f} + {n}_{s , f}^{μ} - {T}_{offset}}{{T}_{SRS}} - {n\_offset}_{SRS , UL} ) \cdot ( \frac{{N}_{symb}^{SRS}}{R} ) + ⌊ {l}^{′} / R ⌋$$

In the formulas 2 and 3, SRS transmission occurs only in a slot that meets (Nₛₗₒₜ^{frame,μ}n_{f}+n_{s,f}^{μ}−T_{offset})modT_{SRS}=0. n_{SRS} is used for counting SRS transmissions in the slot. For meanings of other parameters, refer to the formula 1.

It can be understood that, in the manner 1, the maximum number of SRS resources in a single SRS resource set may remain unchanged based on an existing stipulation/limitation.

For example, SRS resources in a single SRS resource set may correspond to a same configuration status. In addition, when only a single set of configuration information is correspondingly configured for each SRS resource, only the first set of configuration information or the second set of configuration information may be configured. When two sets of configuration information are correspondingly configured for each SRS resource, applied configuration information may be determined in any one of the manners (1) to (3). In this case, SRS transmission behaviors corresponding to SRS resources in a single SRS resource set (as a (smallest) granularity for MAC CE activation/deactivation or DCI triggering) are usually consistent. The SRS resource set may be used as a (smallest) granularity for Medium Access Control Control Element (MAC CE) activation/deactivation or a (smallest) granularity for DCI triggering.

For example, statuses corresponding to SRS resources in an SRS resource set may not be completely the same. For example, when only a single set of configuration information is correspondingly configured for each SRS resource, sequence numbers of configuration information are different; or when two sets of configuration information are correspondingly configured for each SRS resource, configuration information is determined in different manners. In this case, corresponding SRS transmission behaviors may be separately determined for the SRS resources in the SRS resource set.

Manner 2: If only a single set of configuration information is configured for a single SRS resource in a first SRS resource set, for a first transmission occasion, the terminal determines, according to a predefined requirement, SRS resources valid for transmissions in the first SRS resource set (in a manner 2-1), or SRS transmissions valid for initiation among SRS transmissions corresponding to SRS resources in the first SRS resource set (in a manner 2-2). The first SRS resource set is a single SRS resource set configured by a network-side device for the terminal. The first transmission occasion is a single transmission occasion corresponding to first SRS resource set.

To be specific, for a specific transmission occasion of the SRS resource set, an SRS resource valid for transmission or SRS transmission valid for initiation among SRS transmission corresponding to each SRS resource may be determined through filtering according to the predefined requirement.

For example, for an aperiodic SRS resource set, a single occasion may be determined based on triggering DCI, and each SRS resource in the aperiodic SRS resource set and the occasion correspond to a same slot. For a periodic/semi-static SRS resource set, each occasion may be determined based on a configured cycle, and each SRS resource in the periodic/semi-static SRS resource set and one occasion may correspond to a same slot or different slots.

For example, for a specific occasion of an SRS resource set, for each SRS resource in the SRS resource set, based on whether the SRS resource meets the predefined requirement in a slot corresponding to the occasion, it may be determined whether the SRS resource is valid for transmission (corresponding to the manner 2-1); or based on whether specific transmission on the SRS resource in a slot corresponding to the occasion meets the predefined requirement in the slot, it may be determined whether the SRS transmission can be performed (corresponding to the manner 2-2).

For example, the predefined requirement may include at least one of the following:

(1) A time domain unit occupied by an SRS resource in a slot corresponding to the first transmission occasion (corresponding to the manner 2-1), or a time domain unit occupied by an SRS transmission corresponding to the SRS resource in the slot corresponding to the first transmission occasion (corresponding to the manner 2-2), corresponds to a type of time domain units that is configured for the SRS resource and that is valid for transmission.

Herein, a type of a time domain unit that is valid for transmission and that is configured for each SRS resource may be any one of the following: the first type of time domain units; the second type of time domain units; or the first type of time domain units and the second type of time domain units.

(2) A first PRB is within a first frequency domain range, where the first frequency domain range is a frequency domain range of valid uplink resources corresponding to a time domain unit occupied by an SRS resource in a slot corresponding to the first transmission occasion. This may be applied to the manner 2-1 and the manner 2-2.

For example, the first PRB may include any one of the following:
all PRBs at a first layer/top layer in a frequency domain hierarchical structure of the SRS resource, where for example, the frequency domain hierarchical structure may be determined based on a frequency domain shift freqDomainShift and a frequency hopping parameter c-SRS, and the first layer/top layer in the frequency domain hierarchical structure may correspond to m_{SRS,0} PRBs of a layer with B_{SRS}=0; or
all PRBs at a frequency hopping layer in a frequency domain hierarchical structure of the SRS resource, where for example, the frequency domain hierarchical structure may be determined based on a frequency domain shift freqDomainShift and a frequency hopping parameter c-SRS, the frequency hopping layer may be determined based on a frequency hopping parameter b-hop (namely, bₕₒₚ) and the frequency domain shift freqDomainPosition, and the frequency hopping layer in the frequency domain hierarchical structure may correspond to m_{SRS,b}_{ₕₒₚ} PRBs; or
a union of PRBs corresponding to one or more SRS transmissions expected to occur for the SRS resource in a corresponding slot.

(3) Any PRB occupied by an SRS transmission is within a second frequency domain range, where the second frequency domain range is a frequency domain range of valid uplink resources corresponding to a time domain unit occupied by the SRS transmission in a slot corresponding to the first transmission occasion. This may be applied to the manner 2-2.

### Configuration Manner 2

In this configuration manner, a limitation on the number of configured SRS resource sets is extended. For example, for SRS resource sets whose usage is codebook/nonCodebook, at least two SRS resource sets are allowed to be configured. To be specific, the first object includes at least two SRS resource sets. Among the at least two SRS resource sets configured, at least one SRS resource set corresponds to the first type of time domain units, and other SRS resource sets except for the at least one SRS resource set corresponds to the second type of time domain units. The correspondence herein may be specified in a protocol or configured by using higher layer signaling. For example, the protocol specifies that a first SRS resource set configured corresponds to the first type of time domain units or the second type of time domain units, and a second SRS resource set configured corresponds to the second type of time domain units or the first type of time domain units. For example, for each SRS resource set configured, a type of a time domain unit corresponding to the SRS resource set is explicitly configured. It is assumed that the corresponding time domain unit is a time domain unit of a specified type, and when the time domain unit of the specified type is the first type of time domain units, a time domain unit of another type is the second type of time domain units; or when the time domain unit of the specified type is the second type of time domain units, a time domain unit of another type is the first type of time domain units.

For example, if at least two SRS resource sets are configured, the terminal may determine an invalid resource/invalid transmission in the following manners.

(1) If a time domain unit (for example, corresponding to nrofSymbols symbols) occupied by a fourth SRS resource in a fifth slot (for example, a specific slot) overlaps with a time domain unit of another type based on third configuration information, the terminal may perform one of the following:
Determine that the fourth SRS resource is invalid/unavailable in the fifth slot. In this case, the terminal does not initiate corresponding SRS transmission, and the time domain unit of the another type is considered as an invalid time domain unit.
When a second predefined condition is not met in at least one overlapping time domain unit of the another type (to be specific, at least one time domain unit among occupied time domain units of the another type), determine that the fourth SRS resource is invalid/unavailable in the fifth slot. In this case, the terminal does not initiate corresponding SRS transmission, and when the second predefined condition is met, the time domain unit of the another type is considered as a valid time domain unit; or otherwise, the time domain unit of the another type is considered as an invalid time domain unit.

(2) If a time domain unit (for example, corresponding to repetitionFactor symbols among nrofSymbols symbols) occupied by a fourth transmission for a fourth SRS resource in a sixth slot (for example, a specific slot) overlaps with a time domain unit of the another type based on third configuration information, the terminal may perform one of the following:
Determine that the fourth transmission is invalid/unavailable in the sixth slot. In this case, the terminal does not initiate corresponding SRS transmission, and the time domain unit of the another type is considered as an invalid time domain unit.
When a second predefined condition is not met in at least one overlapping time domain unit of the another type (to be specific, at least one time domain unit among occupied time domain units of the another type), determine that the fourth transmission is invalid/unavailable in the sixth slot. In this case, the terminal does not initiate corresponding SRS transmission, and when the second predefined condition is met, the time domain units of another type are considered as valid time domain units; or otherwise, the time domain units of another type are considered as invalid time domain units.

(3) If all time domain units (for example, corresponding to nrofSymbols symbols) occupied by a fourth SRS resource in a seventh slot (for example, a specific slot) are time domain units of another type based on third configuration information, the terminal may perform one of the following:
Determine that the fourth SRS resource is invalid/unavailable in the seventh slot. In this case, the terminal does not initiate corresponding SRS transmission, and all the time domain units of another type are considered as invalid time domain units.
When a second predefined condition is met in none of the occupied time domain units of the another type (to be specific, all of the occupied time domain units of the another type), determine that the fourth SRS resource is invalid/unavailable in the seventh slot. In this case, the terminal does not initiate corresponding SRS transmission, and when the second predefined condition is met, the time domain units of another type are considered as valid time domain units; or otherwise, the time domain units of another type are considered as invalid time domain units.

(4) If all time domain units (for example, corresponding to repetitionFactor symbols among nrofSymbols symbols) occupied by fifth transmission on a fourth SRS resource in an eighth slot (for example, a specific slot) are time domain units of another type based on third configuration information, the terminal may perform one of the following:
Determine that the fifth transmission is invalid/unavailable in the eighth slot. In this case, the terminal does not initiate corresponding SRS transmission, and all the time domain units of another type are considered as invalid time domain units.
When a second predefined condition is met in none of the occupied time domain units of the another type (to be specific, all of the occupied time domain units of the another type), determine that the fifth transmission is invalid/unavailable in the eighth slot. In this case, the terminal does not initiate corresponding SRS transmission, and when the second predefined condition is met, the time domain units of another type are considered as valid time domain units; or otherwise, the time domain units of another type are considered as invalid time domain units.

The fourth SRS resource is a single SRS resource in a second SRS resource set. The third configuration information is configuration information corresponding to the fourth SRS resource. The second SRS resource set is any one of the at least two SRS resource sets configured. A type of a time domain unit corresponding to the second SRS resource set is different from a type of the time domain unit of the another type. For example, the time domain unit corresponding to the second SRS resource set is the first type of time domain units, and the time domain unit of the another type is the second type of time domain units; or the time domain unit corresponding to the second SRS resource set is the second type of time domain units, and the time domain unit of the another type is the first type of time domain units.

It should be noted that the overlapping may be understood as that at least one of time domain units occupied by the fourth SRS resource/the fourth transmission is the time domain unit of the another type. A predefined method may be used for processing a collision between a time domain unit occupied by the fourth SRS resource in a specific slot or a time domain unit occupied by specific transmission in a specific slot based on the corresponding third configuration information and a time domain unit (for example, a semi-static DL time domain unit not configured with a UL sub-band, and/or a semi-static flexible time domain unit in which no flexible duplex operation is allowed) other than the first-type/second type of time domain units in this application. For the predefined method, refer to the foregoing descriptions.

It can be understood that, in (1) to (4), whether to determine an invalid resources/invalid transmission based on the second predefined condition may be specified in a protocol; or may be uniformly configured for the terminal, serving cells configured with SRS transmission, UL BWPs configured with SRS transmission, or SRS Configs, or separately configured for various types of usage of SRS transmission corresponding to a specific SRS Config, or separately configured for each SRS resource set, or separately configured for each SRS resource included in a specific SRS resource set.

For example, when a corresponding SRS transmission is determined for a fourth SRS resource, the terminal may perform one of the following:
not expecting that the fourth SRS resource overlaps with a time domain unit of another type in any slot (for example, corresponding to a plurality of slots when resource Type is periodic/semi-persistent, or corresponding to a single slot when resourceType is aperiodic) for transmission, or not expecting that the fourth SRS resource does not meet a second predefined condition in at least one overlapping time domain unit of another type, when overlapping exists, in any slot for transmission;
not expecting that any SRS transmission corresponding to the fourth SRS resource overlaps with a time domain unit of another type, or not expecting that any SRS transmission corresponding to the fourth SRS resource does not meet a second predefined condition in at least one overlapping time domain unit of another type when overlapping exists;
not expecting that all time domain units occupied by the fourth SRS resource in any slot for transmission are time domain units of another type, or not expecting that all time domain units occupied by the fourth SRS resource in any slot for transmission are time domain units of another type, and that the first SRS resource does not meet a second predefined condition in each occupied time domain unit of another type; or
not expecting that all time domain units occupied by any SRS transmission corresponding to the fourth SRS resource are time domain units of another type, or not expecting that all time domain units occupied by any SRS transmission corresponding to the fourth SRS resource are time domain units of another type, and that any SRS transmission corresponding to the fourth SRS resource does not meet a second predefined condition in each occupied time domain unit of another type.

The fourth SRS resource is a single SRS resource in a third SRS resource set. The third SRS resource set is any one of the at least two SRS resource sets configured. A type of a time domain unit corresponding to the third SRS resource set is different from a type of the time domain unit of the another type. For example, the time domain unit corresponding to the third SRS resource set is the first type of time domain units, and the time domain unit of the another type is the second type of time domain units; or the time domain unit corresponding to the third SRS resource set is the second type of time domain units, and the time domain unit of the another type is the first type of time domain units.

For example, the second predefined condition may include at least one of the following:
(i) A frequency domain range corresponding structure to all PRBs at a first layer/top layer in a frequency domain hierarchical structure of the fourth SRS resource is within a frequency domain range corresponding to an uplink sub-band. For example, the frequency domain hierarchical structure may be determined based on a frequency domain shift freqDomainShift and a frequency hopping parameter c-SRS. The first layer/top layer in the frequency domain hierarchical structure may correspond to m_{SRS,0} PRBs of a layer with B_{SRS}=0.
(ii) A frequency domain range corresponding to all PRBs at a frequency hopping layer in a frequency domain hierarchical structure of the fourth SRS resource is within a frequency domain range corresponding to an uplink sub-band. For example, the frequency domain hierarchical structure may be determined based on a frequency domain shift freqDomainShift and a frequency hopping parameter c-SRS, and the frequency hopping layer may be determined based on a frequency hopping parameter b-hop (namely, bₕₒₚ) and the frequency domain shift freqDomainPosition. The frequency hopping layer in the frequency domain hierarchical structure may correspond to m_{SRS,b}_{ₕₒₚ} PRBs.
(iii) A union of frequency domain ranges corresponding to one or more SRS transmissions expected to occur for the fourth SRS resource in a corresponding slot is within a frequency domain range corresponding to an uplink sub-band.
(iv) A frequency domain range corresponding to a corresponding transmission for the fourth SRS resource in a corresponding slot is within a frequency domain range corresponding to an uplink sub-band.

For example, if at least two SRS resource sets are configured, the terminal may receive first non-fallback scheduling DCI, for example, a DCI format 0_1/0_2. A first SRS Resource Indicator (SRI) in the first non-fallback scheduling DCI may be indicated by an SRI indicator field, and may meet any one of the following:

(a) An SRS resource set (for example, corresponding usage is nonCodebook) corresponding to a single SRS resource (for example, corresponding usage is codebook) or an SRS resource combination/subset indicated by the first SRI is an SRS resource set corresponding to a type of a time domain unit in which a PUSCH scheduled by the first non-fallback scheduling DCI is located.

In (a), when the scheduled PUSCH occupies a plurality of time domain units, the terminal expects that the plurality of time domain units correspond to a same type, or that types corresponding to the plurality of time domain units correspond to a same SRS resource set. Further, when the number of corresponding SRS resource sets is greater than 1, a specific SRS resource set to be applied may be determined in at least one of the following manners: being specified in a protocol, where for example, an SRS resource set with a smallest/largest ID is applied; being configured by higher layer signaling, where for example, an SRS resource set at a specific position in a queue sorted in ascending/descending order based on IDs is configured to be applied; or being indicated by DCI, where for example, an SRS resource set at a specific position in a queue sorted in ascending/descending order based on IDs is indicated to be applied.

(b) An SRS resource set corresponding to a single SRS resource (for example, corresponding usage is codebook) or an SRS resource subset (for example, corresponding usage is nonCodebook) indicated by the first SRI is indicated based on the first non-fallback scheduling DCI.

For example, the first non-fallback scheduling DCI may directly indicate an SRS resource set, among SRS resource sets whose usage is codebook or nonCodebook, that is at a specific position in a queue sorted in ascending/descending order based on IDs, or directly indicate an ID corresponding to an SRS resource set.

### Configuration Manner 3

In this configuration manner, the first object includes at least two SRS configurations. To be specific, at least two SRS configurations are configured, and each of the at least two SRS configurations configured corresponds to the first type of time domain units or the second type of time domain units. The correspondence herein may be specified in a protocol or configured by using higher layer signaling. For example, the protocol specifies that a first SRS Config configured corresponds to the first type of time domain units or the second type of time domain units, and a second SRS Config configured corresponds to the second type of time domain units or the first type of time domain units. For example, for each SRS Config configured, a type of a time domain unit corresponding to the SRS Config is explicitly configured. It is assumed that the corresponding time domain unit is a time domain unit of a specified type, and when the time domain unit of the specified type is the first type of time domain units, a time domain unit of another type is the second type of time domain units; or when the time domain unit of the specified type is the second type of time domain units, a time domain unit of another type is the first type of time domain units.

For example, if at least two SRS configurations are configured, the terminal may determine an invalid configuration/invalid transmission in the following manners.

(1) If a time domain unit (for example, corresponding to nrofSymbols symbols) occupied by a fourth SRS resource in a fifth slot (for example, a specific slot) overlaps with a time domain unit of another type based on third configuration information, the terminal may perform one of the following:
Determine that the fourth SRS resource is invalid/unavailable in the fifth slot. In this case, the terminal does not initiate corresponding SRS transmission, and the time domain unit of the another type is considered as an invalid time domain unit.
When a second predefined condition is not met in at least one overlapping time domain unit of the another type (to be specific, at least one time domain unit among occupied time domain units of the another type), determine that the fourth SRS resource is invalid/unavailable in the fifth slot. In this case, the terminal does not initiate corresponding SRS transmission, and when the second predefined condition is met, the time domain unit of the another type is considered as a valid time domain unit; or otherwise, the time domain unit of the another type is considered as an invalid time domain unit.

(2) If a time domain unit (for example, corresponding to repetitionFactor symbols among nrofSymbols symbols) occupied by a fourth transmission for a fourth SRS resource in a sixth slot (for example, a specific slot) overlaps with a time domain unit of the another type based on third configuration information, the terminal may perform one of the following:
Determine that the fourth transmission is invalid/unavailable in the sixth slot. In this case, the terminal does not initiate corresponding SRS transmission, and the time domain unit of the another type is considered as an invalid time domain unit.
When a second predefined condition is not met in at least one overlapping time domain unit of the another type (to be specific, at least one time domain unit among occupied time domain units of the another type), determine that the fourth transmission is invalid/unavailable in the sixth slot. In this case, the terminal does not initiate corresponding SRS transmission, and when the second predefined condition is met, the time domain units of another type are considered as valid time domain units; or otherwise, the time domain units of another type are considered as invalid time domain units.

(3) If all time domain units (for example, corresponding to nrofSymbols symbols) occupied by a fourth SRS resource in a seventh slot (for example, a specific slot) are time domain units of another type based on third configuration information, the terminal may perform one of the following:
Determine that the fourth SRS resource is invalid/unavailable in the seventh slot. In this case, the terminal does not initiate corresponding SRS transmission, and all the time domain units of another type are considered as invalid time domain units.
When a second predefined condition is met in none of the occupied time domain units of the another type (to be specific, all of the occupied time domain units of the another type), determine that the fourth SRS resource is invalid/unavailable in the seventh slot. In this case, the terminal does not initiate corresponding SRS transmission, and when the second predefined condition is met, the time domain units of another type are considered as valid time domain units; or otherwise, the time domain units of another type are considered as invalid time domain units.

(4) If all time domain units (for example, corresponding to repetitionFactor symbols among nrofSymbols symbols) occupied by fifth transmission on a fourth SRS resource in an eighth slot (for example, a specific slot) are time domain units of another type based on third configuration information, the terminal may perform one of the following:
Determine that the fifth transmission is invalid/unavailable in the eighth slot. In this case, the terminal does not initiate corresponding SRS transmission, and all the time domain units of another type are considered as invalid time domain units.
When a second predefined condition is met in none of the occupied time domain units of the another type (to be specific, all of the occupied time domain units of the another type), determine that the fifth transmission is invalid/unavailable in the eighth slot. In this case, the terminal does not initiate corresponding SRS transmission, and when the second predefined condition is met, the time domain units of another type are considered as valid time domain units; or otherwise, the time domain units of another type are considered as invalid time domain units.

The fourth SRS resource is a single SRS resource in a single SRS resource set configured for specific usage in a first SRS configuration. The third configuration information is configuration information corresponding to the fourth SRS resource. The first SRS configuration is any one of the at least two SRS configurations configured. The specific usage is, for example, codebook/nonCodebook. A type of a time domain unit corresponding to the first SRS configuration is different from a type of the time domain unit of the another type. For example, the time domain unit corresponding to the first SRS configuration is the first type of time domain units, and the time domain unit of the another type is the second type of time domain units; or the time domain unit corresponding to the first SRS configuration is the second type of time domain units, and the time domain unit of the another type is the first type of time domain units.

It should be noted that the overlapping may be understood as that at least one of time domain units occupied by the fourth SRS resource/the fourth transmission is the time domain unit of the another type. A predefined method may be used for processing a collision between a time domain unit occupied by the fourth SRS resource in a specific slot or a time domain unit occupied by specific transmission in a specific slot based on the corresponding third configuration information and a time domain unit (for example, a semi-static DL time domain unit not configured with a UL sub-band, and/or a semi-static flexible time domain unit in which no flexible duplex operation is allowed) other than the first-type/second type of time domain units in this application. For the predefined method, refer to the foregoing descriptions.

It can be understood that, in (1) to (4), whether to determine an invalid resources/invalid transmission based on the second predefined condition may be specified in a protocol; or may be uniformly configured for the terminal, serving cells configured with SRS transmission, UL BWPs configured with SRS transmission, or SRS Configs, or separately configured for various types of usage of SRS transmission corresponding to a specific SRS Config, or separately configured for each SRS resource set, or separately configured for each SRS resource included in a specific SRS resource set.

For example, when a corresponding SRS transmission is determined for a fourth SRS resource, the terminal may perform one of the following:
not expecting that the fourth SRS resource overlaps with a time domain unit of another type in any slot (for example, corresponding to a plurality of slots when resourceType is periodic/semi-persistent, or corresponding to a single slot when resourceType is aperiodic) for transmission, or not expecting that the fourth SRS resource does not meet a second predefined condition in at least one overlapping time domain unit of another type, when overlapping exists, in any slot for transmission;
not expecting that any SRS transmission corresponding to the fourth SRS resource overlaps with a time domain unit of another type, or not expecting that any SRS transmission corresponding to the fourth SRS resource does not meet a second predefined condition in at least one overlapping time domain unit of another type when overlapping exists;
not expecting that all time domain units occupied by the fourth SRS resource in any slot for transmission are time domain units of another type, or not expecting that all time domain units occupied by the fourth SRS resource in any slot for transmission are time domain units of another type, and that the first SRS resource does not meet a second predefined condition in each occupied time domain unit of another type; or
not expecting that all time domain units occupied by any SRS transmission corresponding to the fourth SRS resource are time domain units of another type, or not expecting that all time domain units occupied by any SRS transmission corresponding to the fourth SRS resource are time domain units of another type, and that any SRS transmission corresponding to the fourth SRS resource does not meet a second predefined condition in each occupied time domain unit of another type.

The fourth SRS resource is a single SRS resource in a single SRS resource set configured for specific usage in a second SRS configuration. The second SRS configuration is a single SRS configuration among the at least two SRS configurations configured. The specific usage is, for example, codebook/nonCodebook. A type of a time domain unit corresponding to the second SRS configuration is different from a type of the time domain unit of the another type. For example, the time domain unit corresponding to the second SRS configuration is the first type of time domain units, and the time domain unit of the another type is the second type of time domain units; or the time domain unit corresponding to the second SRS configuration is the second type of time domain units, and the time domain unit of the another type is the first type of time domain units.

For example, for the second predefined condition, refer to the foregoing content. Details are not described herein again.

For example, if at least two SRS configurations are configured, the terminal may receive second non-fallback scheduling DCI, for example, a DCI format 0_1/0_2. A second SRI in the second non-fallback scheduling DCI may be indicated by an SRI indicator field, and may meet any one of the following:

(a) An SRS configuration corresponding to a single SRS resource (for example, corresponding usage is codebook) or an SRS resource combination/subset (for example, corresponding usage is nonCodebook) indicated by the second SRI is an SRS configuration corresponding to a type of a time domain unit in which a PUSCH scheduled by the second non-fallback scheduling DCI is located.

In (a), when the scheduled PUSCH occupies a plurality of time domain units, the terminal expects that the plurality of time domain units correspond to a same type, or that types corresponding to the plurality of time domain units correspond to a same SRS Config. Further, when the number of corresponding SRS Configs is greater than 1, a specific SRS Config to be applied may be determined in at least one of the following manners: being specified in a protocol, where for example, an SRS Config with a smallest/largest ID is applied; being configured by higher layer signaling, where for example, an SRS Config at a specific position in a queue sorted in ascending/descending order based on IDs is configured to be applied; or being indicated by DCI, where for example, an SRS Config at a specific position in a queue sorted in ascending/descending order based on IDs is indicated to be applied.

(b) An SRS Config corresponding to a single SRS resource (combination/for example, corresponding usage is codebook) or an SRS resource combination/subset (for example, corresponding usage is nonCodebook) indicated by the second SRI is indicated based on the second non-fallback scheduling DCI.

For example, the second non-fallback scheduling DCI may indicate an ID corresponding to an applied SRS Config.

It can be understood that, for each SRS Config, an existing limitation on the number of SRS resource sets may still be used. For example, at most one SRS resource set whose usage is codebook/nonCodebook is allowed to be configured for a single SRS Config.

It should be noted that, in the configuration manner 1 to the configuration manner 3, usage of a corresponding SRS resource set may be codebook/nonCodebook.

When usage of an SRS resource set is beamManagement, a plurality of SRS resource sets with usage set to beamManagement may be configured for a single UL BWP/SRS Config of a single terminal. The plurality of SRS resource sets focus on differentiation in an antenna panel dimension and a resource type dimension, and may be enhanced for the flexible duplex mode to distinguish between different types of time domain units. For example, the configuration manner 1 may be used. To be specific, different types of time domain units are matched based on a granularity of SRS resource. For example, the configuration manner 2 may be used. To be specific, different types of time domain units are matched based on a granularity of SRS resource set, and a plurality of SRS resource sets configured may be divided into at least two SRS resource subsets, where at least one SRS resource subset corresponds to the first type of time domain units, and at least one SRS resource subset corresponds to the second type of time domain units. For example, the configuration manner 3 may be used. To be specific, different types of time domain units are matched based on a granularity of SRS Config.

When usage of an SRS resource set is antennaSwitching, a maximum of two SRS resource sets with usage set to ‘antennaSwitching’ may be configured for a single UL BWP/SRS Config of a single terminal. The plurality of SRS resource sets focus on differentiation in a resource type or port dimension or the like, and may be enhanced for the flexible duplex mode to distinguish between different types of time domain units. For example, the configuration manner 1 may be used. To be specific, different types of time domain units are matched based on a granularity of SRS resource. For example, the configuration manner 2 may be used. To be specific, different types of time domain units are matched based on a granularity of SRS resource set, and a plurality of SRS resource sets configured may be divided into at least two SRS resource subsets, where at least one SRS resource subset corresponds to the first type of time domain units, and at least one SRS resource subset corresponds to the second type of time domain units. For example, the configuration manner 3 may be used. To be specific, different types of time domain units are matched based on a granularity of SRS Config.

FIG. 5 is a flowchart of an information configuration method according to an embodiment of this application. The method is applied to a network-side device. As shown in FIG. 5, the method includes the following steps.

Step 51: The network-side device sends first configuration information to a terminal.

In this embodiment, in the first configuration information, a maximum of M sets of configuration information are configured for a single SRS resource (for example, SRS Resource), each set of configuration information corresponds to a time domain unit meeting a specific requirements, and M is an integer greater than 1; and/or the first configuration information is used for configuring a first object, the first object, after being configured, corresponds to a time domain unit meeting a specific requirement, and the first object includes at least one of the following: at least two SRS resource sets or at least two SRS configurations (for example, SRS Config).

In this way, for SRS transmission, parameters, such as a time domain/frequency domain/code domain parameter, a power-related parameter, and a spatial relation-related parameter, that match characteristics of different uplink resources may be configured for the uplink resources. In this way, different uplink resources are fully utilized based on characteristics of the uplink resources, to ensure SRS transmission performance.

For example, the time domain unit meeting the specific requirement may include a first type of time domain units and/or a second type of time domain units, the first type of time domain units is a time domain unit with a valid uplink resource in an uplink BWP range, and the second type of time domain units is a time domain unit with a valid uplink resource only in an uplink sub-band range.

For example, the first type of time domain units may include at least one of the following:
(1) A semi-static uplink time domain unit.
(2) A first semi-static flexible time domain unit. In the first semi-static flexible time domain unit, all the frequency domain range corresponding to an uplink BWP can be used as valid uplink resources. In other words, the frequency domain limitation mode 2 is used. The first semi-static flexible time domain unit is a semi-static flexible time domain unit in which a flexible duplex operation is allowed.

It can be understood that the first semi-static flexible time domain unit herein does not include an SSB time domain unit in the SSB collision limitation mode 1.

For example, the second type of time domain units may include at least one of the following:

(1) A semi-static downlink time domain unit, to be specific, a semi-static DL time domain unit configured to have a UL sub-band.

It can be understood that the semi-static DL time domain unit herein does not include an SSB time domain unit in the SSB collision limitation mode 1.

(2) A second semi-static flexible time domain unit. In the second semi-static flexible time domain unit, only the frequency domain range corresponding to an uplink sub-band can be used as valid uplink resources. In other words, the frequency domain limitation mode 1 is used. The second semi-static flexible time domain unit is a semi-static flexible time domain unit in which a flexible duplex operation is allowed.

It can be understood that the second semi-static flexible time domain unit herein does not include SSB time domain unit in the SSB collision limitation mode 1.

For example, if only a single set of configuration information is configured for a single SRS resource, the single set of configuration information corresponds to the first type of time domain units or the second type of time domain units; or if two sets of configuration information are configured for a single SRS resource and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units.

For example, if two sets of configuration information are configured for a single SRS resource, the network-side device may send first higher layer signaling and/or first DCI to the terminal, where the first higher layer signaling and/or the first DCI are used for the terminal to determine applied configuration information from the two sets of configuration information.

For example, the applied configuration information meets any one of the following:
corresponding to a type of a time domain unit in which an SRS resource triggered by the first DCI is located;
being indicated by a first indicator field in the first DCI; or
an SRS request and the applied configuration information are jointly indicated by a second indicator field in the first DCI.

For example, the first object includes at least two SRS resource sets, and among the at least two SRS resource sets configured, at least one SRS resource set corresponds to the first type of time domain units, and other SRS resource sets except for the at least one SRS resource set corresponds to the second type of time domain units; and/or
when the first object includes at least two SRS configurations, each of the at least two SRS configurations configured corresponds to the first type of time domain units or the second type of time domain units.

For example, when the first object includes at least two SRS resource sets, the network-side device may send first non-fallback scheduling DCI, where a first SRI in the first non-fallback scheduling DCI meets any one of the following:
an SRS resource set corresponding to a single SRS resource or an SRS resource subset indicated by the first SRI is an SRS resource set corresponding to a type of a time domain unit in which a PUSCH scheduled by the first non-fallback scheduling DCI is located; or
an SRS resource set corresponding to a single SRS resource or an SRS resource subset indicated by the first SRI is indicated based on the first non-fallback scheduling DCI.

For example, when the first object includes at least two SRS configurations, the network-side device may send second non-fallback scheduling DCI, where a second SRI in the second non-fallback scheduling DCI meets any one of the following:
an SRS configuration corresponding to a single SRS resource or an SRS resource subset indicated by the second SRI is an SRS configuration corresponding to a type of a time domain unit in which a PUSCH scheduled by the second non-fallback scheduling DCI is located; or
an SRS configuration corresponding to a single SRS resource or an SRS resource subset indicated by the second SRI is indicated based on the second non-fallback scheduling DCI.

The information configuration method provided in the embodiments of this application may be performed by an information configuration apparatus. In the embodiments of this application, an information configuration apparatus provided in the embodiments of this application is described by using an example in which the information configuration apparatus performs the information configuration method.

FIG. 6 is a schematic structural diagram of an information configuration apparatus according to an embodiment of this application. The apparatus is applied to a terminal. As shown in FIG. 6, the information configuration apparatus 60 includes:
a receiving module 61, configured to receive first configuration information from a network-side device, where
in the first configuration information, a maximum of M sets of configuration information are configured for a single SRS resource, each set of configuration information corresponds to a time domain unit meeting a specific requirements, and M is an integer greater than 1; and/or
the first configuration information is used for configuring a first object, the first object, after being configured, corresponds to a time domain unit meeting a specific requirement, and the first object includes at least one of the following: at least two SRS resource sets or at least two SRS configurations.

For example, the time domain unit meeting the specific requirement includes a first type of time domain units and/or a second type of time domain units, the first type of time domain units is any time domain unit with a valid uplink resource in an uplink bandwidth part BWP range, and the second type of time domain units is any time domain unit with a valid uplink resource only in an uplink sub-band range.

For example, the first type of time domain units includes at least one of the following:
a semi-static uplink time domain unit; or
a first semi-static flexible time domain unit, where in the first semi-static flexible time domain unit, all the frequency domain range corresponding to an uplink BWP can be used as valid uplink resources; and/or
the second type of time domain units includes at least one of the following:
a semi-static downlink time domain unit; or
a second semi-static flexible time domain unit, where in the second semi-static flexible time domain unit, only the frequency domain range corresponding to an uplink sub-band can be used as valid uplink resources.

For example, if only a single set of configuration information is configured for a single SRS resource, the single set of configuration information corresponds to the first type of time domain units or the second type of time domain units; or
if two sets of configuration information are configured for a single SRS resource and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units.

For example, if two sets of configuration information are configured for a single SRS resource, the information configuration apparatus 60 further includes:
a first determining module, configured to determine applied configuration information from the two sets of configuration information based on at least one of the following:
a type of a time domain unit in which the SRS resource is located, or a type of a time domain unit in which a first transmission on the SRS resource is located;
first higher layer signaling; or
first downlink control information DCI.

For example, when the applied configuration information is determined from the two sets of configuration information based on the first DCI, the applied configuration information meets any one of the following:
corresponding to a type of a time domain unit in which an SRS resource triggered by the first DCI is located;
being indicated by a first indicator field in the first DCI; or
an SRS request and the applied configuration information are jointly indicated by a second indicator field in the first DCI.

For example, the information configuration apparatus 60 further includes:
a first execution module, configured to perform any one of the following:
if a time domain unit occupied by a first SRS resource in a first slot overlaps with a time domain unit of another type based on second configuration information, performing one of the following: determining that the first SRS resource is invalid in the first slot, or when a first predefined condition is not met in at least one overlapping time domain unit of the another type, determining that the first SRS resource is invalid in the first slot;
if a time domain unit occupied by a second transmission on a first SRS resource in a second slot overlaps with a time domain unit of another type based on second configuration information, performing one of the following: determining that the second transmission is invalid in the second slot, or when a first predefined condition is not met in at least one overlapping time domain unit of the another type, determining that the second transmission is invalid in the second slot;
if all time domain units occupied by a first SRS resource in a third slot are time domain units of another type based on second configuration information, performing one of the following: determining that the first SRS resource is invalid in the third slot, or when a first predefined condition is met in none of the occupied time domain units of the another type, determining that the first SRS resource is invalid in the third slot; or
if all time domain units occupied by third transmission on a first SRS resource in a fourth slot are time domain units of another type based on second configuration information, performing one of the following: determining that the third transmission is invalid in the fourth slot, or when a first predefined condition is met in none of the occupied time domain units of the another type, determining that the third transmission is invalid in the fourth slot, where
the second configuration information is a single set of configuration information configured for the first SRS resource, or the second configuration information is a set of configuration information determined from two sets of configuration information configured for the first SRS resource; and
a time domain unit corresponding to the second configuration information is the first type of time domain units, and the time domain unit of the another type is the second type of time domain units; or a time domain unit corresponding to the second configuration information is the second type of time domain units, and the time domain unit of the another type is the first type of time domain units.

For example, if only a single set of configuration information is configured for a first SRS resource and the single set of configuration information is used as applied configuration information, or if two sets of configuration information are configured for a first SRS resource and one set of configuration information is determined from the two sets of configuration information as applied configuration information based on a configuration or an indication, when an SRS transmission corresponding to the first SRS resource is determined by using the applied configuration information, the terminal performs one of the following:
not expecting that the first SRS resource overlaps with a time domain unit of another type in any slot for transmission, or not expecting that the first SRS resource does not meet a first predefined condition in at least one overlapping time domain unit of another type, when overlapping exists, in any slot for transmission;
not expecting that any SRS transmission corresponding to the first SRS resource overlaps with a time domain unit of another type, or not expecting that any SRS transmission corresponding to the first SRS resource does not meet a first predefined condition in at least one overlapping time domain unit of another type when overlapping exists;
not expecting that all time domain units occupied by the first SRS resource in any slot for transmission are time domain units of another type, or not expecting that all time domain units occupied by the first SRS resource in any slot for transmission are time domain units of another type, and that the first SRS resource does not meet a first predefined condition in each occupied time domain unit of another type; or
not expecting that all time domain units occupied by any SRS transmission corresponding to the first SRS resource are time domain units of another type, or not expecting that all time domain units occupied by any SRS transmission corresponding to the first SRS resource are time domain units of another type, and that any SRS transmission corresponding to the first SRS resource does not meet a first predefined condition in each occupied time domain unit of the another type, where
a time domain unit corresponding to the applied configuration information is the first type of time domain units, and the time domain unit of the another type is the second type of time domain units; or a time domain unit corresponding to the applied configuration information is the second type of time domain units, and the time domain unit of the another type is the first type of time domain units.

For example, the first predefined condition includes at least one of the following:
a frequency domain range corresponding to all physical resource blocks PRBs at a first layer in a frequency domain hierarchical structure of the first SRS resource is within a frequency domain range corresponding to an uplink sub-band;
a frequency domain range corresponding to all PRBs at a frequency hopping layer in a frequency domain hierarchical structure of the first SRS resource is within a frequency domain range corresponding to an uplink sub-band;
a union of frequency domain ranges corresponding to one or more SRS transmissions expected to occur for the first SRS resource in a corresponding slot is within a frequency domain range corresponding to an uplink sub-band; or
a frequency domain range corresponding to a corresponding transmission for the first SRS resource in a corresponding slot is within a frequency domain range corresponding to an uplink sub-band.

For example, the information configuration apparatus 60 further includes:
a second execution module, configured to perform any one of the following:
if only a single set of configuration information is applied to SRS transmissions corresponding to a second SRS resource, for each SRS transmission occasion in which the corresponding SRS transmissions cannot be performed, performing a plus-one operation on a first counter, where the first counter is used for counting SRS transmission occasions in which the SRS transmissions cannot be performed; or
if two sets of configuration information are applied to SRS transmission corresponding to a third SRS resource, when an SRS transmission corresponding to the third SRS resource is performed or partially performed once in the first type of time domain units, performing a plus-one operation on a second counter, and when an SRS transmission corresponding to the third SRS resource is performed or partially performed once in the second type of time domain units, performing a plus-one operation on a third counter, where the second counter is used for counting SRS transmissions in the first type of time domain units, and the third counter is used for counting SRS transmissions in the second type of time domain units.

For example, if only a single set of configuration information is configured for a single SRS resource in a first SRS resource set, the information configuration apparatus 60 further includes:
a second determining module, configured to: for a first transmission occasion, determine, according to a predefined requirement, SRS resources valid for transmissions in the first SRS resource set, or SRS transmissions valid for initiation among SRS transmissions corresponding to SRS resources in the first SRS resource set, where the first SRS resource set is a single SRS resource set configured by a network-side device for the terminal, and the first transmission occasion is a single transmission occasion corresponding to the first SRS resource set.

For example, the predefined requirement includes at least one of the following:
a time domain unit occupied by an SRS resource in a slot corresponding to the first transmission occasion, or a time domain unit occupied by an SRS transmission corresponding to the SRS resource in the slot corresponding to the first transmission occasion, corresponds to a type of time domain units that is configured for the SRS resource and that is valid for transmission;
a first PRB is within a first frequency domain range, where the first frequency domain range is a frequency domain range of valid uplink resources corresponding to a time domain unit occupied by an SRS resource in a slot corresponding to the first transmission occasion; or
any PRB occupied by an SRS transmission is within a second frequency domain range, where the second frequency domain range is a frequency domain range of valid uplink resources corresponding to a time domain unit occupied by the SRS transmission in a slot corresponding to the first transmission occasion, where
the first PRB includes any one of the following:
all PRBs at a first layer in a frequency domain hierarchical structure of the SRS resource;
all PRBs at a frequency hopping layer in a frequency domain hierarchical structure of the SRS resource; or
a union of PRBs corresponding to one or more SRS transmissions expected to occur for the SRS resource in a corresponding slot.

For example, the first object includes at least two SRS resource sets, and among the at least two SRS resource sets configured, at least one SRS resource set corresponds to the first type of time domain units, and other SRS resource sets except for the at least one SRS resource set corresponds to the second type of time domain units; and/or
when the first object includes at least two SRS configurations, each of the at least two SRS configurations configured corresponds to the first type of time domain units or the second type of time domain units.

For example, the information configuration apparatus 60 further includes:
a third execution module, configured to perform any one of the following:
if a time domain unit occupied by a fourth SRS resource in a fifth slot overlaps with a time domain unit of another type based on third configuration information, performing one of the following: determining that the fourth SRS resource is invalid in the fifth slot, or when a second predefined condition is not met in at least one overlapping time domain unit of the another type, determining that the fourth SRS resource is invalid in the fifth slot;
if a time domain unit occupied by a fourth transmission for a fourth SRS resource in a sixth slot overlaps with a time domain unit of the another type based on third configuration information, performing one of the following: determining that the fourth transmission is invalid in the sixth slot, or when a second predefined condition is not met in at least one overlapping time domain unit of the another type, determining that the fourth transmission is invalid in the sixth slot;
if all time domain units occupied by a fourth SRS resource in a seventh slot are time domain units of another type based on third configuration information, performing one of the following: determining that the fourth SRS resource is invalid in the seventh slot, or when a second predefined condition is met in none of the occupied time domain units of the another type, determining that the fourth SRS resource is invalid in the seventh slot; or
if all time domain units occupied by fifth transmission on a fourth SRS resource in an eighth slot are time domain units of another type based on third configuration information, performing one of the following: determining that the fifth transmission is invalid in the eighth slot, or when a second predefined condition is met in none of the occupied time domain units of the another type, determining that the fifth transmission is invalid in the eighth slot, where
the fourth SRS resource is a single SRS resource in a second SRS resource set, the third configuration information is configuration information corresponding to the fourth SRS resource, and the second SRS resource set is any one of the at least two SRS resource sets; or the fourth SRS resource is a single SRS resource in a single SRS resource set configured for specific usage in a first SRS configuration, the third configuration information is configuration information corresponding to the fourth SRS resource, and the first SRS configuration is any one of the at least two SRS configurations; and
a time domain unit corresponding to the second SRS resource set or the first SRS configuration is the first type of time domain units, and the time domain unit of the another type is the second type of time domain units; or a time domain unit corresponding to the second SRS resource set or the first SRS configuration is the second type of time domain units, and the time domain unit of the another type is the first type of time domain units.

For example, when a corresponding SRS transmission is determined for a fourth SRS resource, the terminal may perform one of the following:
not expecting that the fourth SRS resource overlaps with a time domain unit of another type in any slot (for example, corresponding to a plurality of slots when resourceType is periodic/semi-persistent, or corresponding to a single slot when resourceType is aperiodic) for transmission, or not expecting that the fourth SRS resource does not meet a second predefined condition in at least one overlapping time domain unit of another type, when overlapping exists, in any slot for transmission;
not expecting that any SRS transmission corresponding to the fourth SRS resource overlaps with a time domain unit of another type, or not expecting that any SRS transmission corresponding to the fourth SRS resource does not meet a second predefined condition in at least one overlapping time domain unit of another type when overlapping exists;
not expecting that all time domain units occupied by the fourth SRS resource in any slot for transmission are time domain units of another type, or not expecting that all time domain units occupied by the fourth SRS resource in any slot for transmission are time domain units of another type, and that the first SRS resource does not meet a second predefined condition in each occupied time domain unit of another type; or
not expecting that all time domain units occupied by any SRS transmission corresponding to the fourth SRS resource are time domain units of another type, or not expecting that all time domain units occupied by any SRS transmission corresponding to the fourth SRS resource are time domain units of another type, and that any SRS transmission corresponding to the fourth SRS resource does not meet a second predefined condition in each occupied time domain unit of another type, where
the fourth SRS resource is a single SRS resource in a third SRS resource set, and the third SRS resource set is a single SRS resource set among the at least two SRS resource sets; or the fourth SRS resource is a single SRS resource in a single SRS resource set configured for specific usage in a second SRS configuration, and the second SRS configuration is a single SRS configuration among the at least two SRS configurations; and a time domain unit corresponding to the third SRS resource set or the second SRS configuration is the first type of time domain units, and the time domain unit of the another type is the second type of time domain units; or a time domain unit corresponding to the third SRS resource set or the second SRS configuration is the second type of time domain units, and the time domain unit of the another type is the first type of time domain units.

For example, the second predefined condition includes at least one of the following:
a frequency domain range corresponding to all PRBs at a first layer in a frequency domain hierarchical structure of the fourth SRS resource is within a frequency domain range corresponding to an uplink sub-band;
a frequency domain range corresponding to all PRBs at a frequency hopping layer in a frequency domain hierarchical structure of the fourth SRS resource is within a frequency domain range corresponding to an uplink sub-band;
a union of frequency domain ranges corresponding to one or more SRS transmissions expected to occur for the fourth SRS resource in a corresponding slot is within a frequency domain range corresponding to an uplink sub-band; or
a frequency domain range corresponding to a corresponding transmission for the fourth SRS resource in a corresponding slot is within a frequency domain range corresponding to an uplink sub-band.

For example, when the first object includes at least two SRS resource sets, the receiving module 61 is further configured to: receive first non-fallback scheduling DCI, where a first SRI in the first non-fallback scheduling DCI meets any one of the following:
an SRS resource set corresponding to a single SRS resource or an SRS resource subset indicated by the first SRI is an SRS resource set corresponding to a type of a time domain unit in which a PUSCH scheduled by the first non-fallback scheduling DCI is located; or
an SRS resource set corresponding to a single SRS resource or an SRS resource subset indicated by the first SRI is indicated based on the first non-fallback scheduling DCI.

For example, when the first object includes at least two SRS configurations, the receiving module 61 is further configured to: receive second non-fallback scheduling DCI, where a second SRI in the second non-fallback scheduling DCI meets any one of the following:
an SRS configuration corresponding to a single SRS resource or an SRS resource subset indicated by the second SRI is an SRS configuration corresponding to a type of a time domain unit in which a PUSCH scheduled by the second non-fallback scheduling DCI is located; or
an SRS configuration corresponding to a single SRS resource or an SRS resource subset indicated by the second SRI is indicated based on the second non-fallback scheduling DCI.

The information configuration apparatus 60 in this embodiment of this application may be an electronic device, for example, an electronic device with an operating system; or may be a component in an electronic device, for example, an integrated circuit or a chip. The electronic device may be a terminal or another device other than the terminal. For example, the terminal may include but is not limited to the aforementioned types of the terminal 11, and the another device may be a server, a Network Attached Storage (NAS), or the like. This is not specifically limited in this embodiment of this application.

The information configuration apparatus 60 provided in this embodiment of this application is capable of implementing the processes implemented in the method embodiment shown in FIG. 3, with the same technical effect achieved. To avoid repetition, details are not described herein again.

FIG. 7 is a schematic structural diagram of an information configuration apparatus according to an embodiment of this application. The apparatus is applied to a network-side device. As shown in FIG. 7, the information configuration apparatus 70 includes:
a sending module 71, configured to send first configuration information to a terminal, where
in the first configuration information, a maximum of M sets of configuration information are configured for a single SRS resource, each set of configuration information corresponds to a time domain unit meeting a specific requirements, and M is an integer greater than 1; and/or
the first configuration information is used for configuring a first object, the first object, after being configured, corresponds to a time domain unit meeting a specific requirement, and the first object includes at least one of the following: at least two SRS resource sets or at least two SRS configurations.

For example, the time domain unit meeting the specific requirement may include a first type of time domain units and/or a second type of time domain units, the first type of time domain units is any time domain unit with a valid uplink resource in an uplink BWP range, and the second type of time domain units is any time domain unit with a valid uplink resource only in an uplink sub-band range.

For example, the first type of time domain units may include at least one of the following:
(1) A semi-static uplink time domain unit.
(2) A first semi-static flexible time domain unit. In the first semi-static flexible time domain unit, all the frequency domain range corresponding to an uplink BWP can be used as valid uplink resources. In other words, the frequency domain limitation mode 2 is used. The first semi-static flexible time domain unit is a semi-static flexible time domain unit in which a flexible duplex operation is allowed.

It can be understood that the first semi-static flexible time domain unit herein does not include an SSB time domain unit in the SSB collision limitation mode 1.

For example, the second type of time domain units may include at least one of the following:

(1) A semi-static downlink time domain unit, to be specific, a semi-static DL time domain unit configured to have a UL sub-band.

It can be understood that the semi-static DL time domain unit herein does not include an SSB time domain unit in the SSB collision limitation mode 1.

(2) A second semi-static flexible time domain unit. In the second semi-static flexible time domain unit, only the frequency domain range corresponding to an uplink sub-band can be used as valid uplink resources. In other words, the frequency domain limitation mode 1 is used. The second semi-static flexible time domain unit is a semi-static flexible time domain unit in which a flexible duplex operation is allowed.

It can be understood that the second semi-static flexible time domain unit herein does not include SSB time domain unit in the SSB collision limitation mode 1.

For example, if only a single set of configuration information is configured for a single SRS resource, the single set of configuration information corresponds to the first type of time domain units or the second type of time domain units; or
if two sets of configuration information are configured for a single SRS resource and the two sets of configuration information include a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units.

For example, if two sets of configuration information are configured for a single SRS resource, the sending module 71 is further configured to: send first higher layer signaling and/or first DCI to the terminal, where the first higher layer signaling and/or the first DCI are used for the terminal to determine applied configuration information from the two sets of configuration information.

For example, the applied configuration information meets any one of the following:
corresponding to a type of a time domain unit in which an SRS resource triggered by the first DCI is located;
being indicated by a first indicator field in the first DCI; or
an SRS request and the applied configuration information are jointly indicated by a second indicator field in the first DCI.

For example, the first object includes at least two SRS resource sets, and among the at least two SRS resource sets configured, at least one SRS resource set corresponds to the first type of time domain units, and other SRS resource sets except for the at least one SRS resource set corresponds to the second type of time domain units; and/or
when the first object includes at least two SRS configurations, each of the at least two SRS configurations configured corresponds to the first type of time domain units or the second type of time domain units.

For example, when the first object includes at least two SRS resource sets, the sending module 71 is further configured to: send first non-fallback scheduling DCI, where a first SRI in the first non-fallback scheduling DCI meets any one of the following:
an SRS resource set corresponding to a single SRS resource or an SRS resource subset indicated by the first SRI is an SRS resource set corresponding to a type of a time domain unit in which a PUSCH scheduled by the first non-fallback scheduling DCI is located; or
an SRS resource set corresponding to a single SRS resource or an SRS resource subset indicated by the first SRI is indicated based on the first non-fallback scheduling DCI.

For example, when the first object includes at least two SRS configurations, the sending module 71 is further configured to: send second non-fallback scheduling DCI, where a second SRI in the second non-fallback scheduling DCI meets any one of the following:
an SRS configuration corresponding to a single SRS resource or an SRS resource subset indicated by the second SRI is an SRS configuration corresponding to a type of a time domain unit in which a PUSCH scheduled by the second non-fallback scheduling DCI is located; or
an SRS configuration corresponding to a single SRS resource or an SRS resource subset indicated by the second SRI is indicated based on the second non-fallback scheduling DCI.

The information configuration apparatus 70 provided in this embodiment of this application is capable of implementing the processes implemented in the method embodiment shown in FIG. 5, with the same technical effect achieved. To avoid repetition, details are not described herein again.

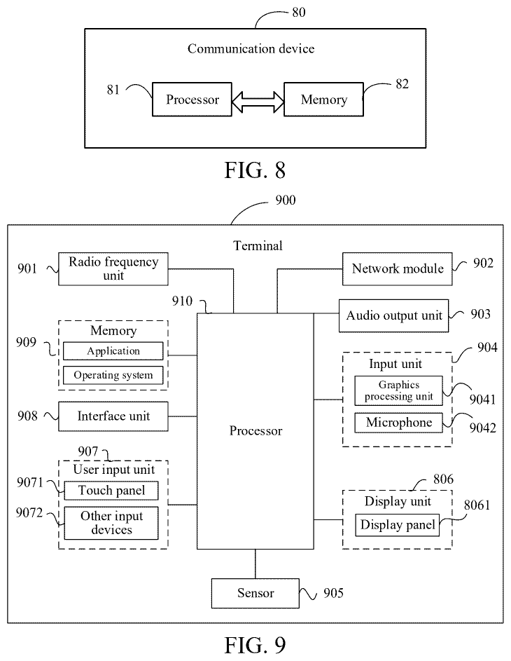

For example, as shown in FIG. 8, an embodiment of this application further provides a communication device 80, including a processor 81 and a memory 82. The memory 82 stores a program or instructions capable of running on the processor 81. For example, in a case that the communication device 80 is a terminal, when the program or instructions are executed by the processor 81, the steps in the embodiment of the information configuration method shown in FIG. 3 are implemented, with the same technical effect achieved. In a case that the communication device 80 is a network-side device, when the program or instructions are executed by the processor 81, the steps in the embodiment of the information configuration method shown in FIG. 5 are implemented, with the same technical effect achieved. To avoid repetition, details are not described herein again.

An embodiment of this application further provides a terminal, including a processor and a communication interface. The communication interface is configured to receive first configuration information from a network-side device, where in the first configuration information, a maximum of M sets of configuration information are configured for a single SRS resource, each set of configuration information corresponds to a time domain unit meeting a specific requirements, and M is an integer greater than 1; and/or the first configuration information is used for configuring a first object, the first object, after being configured, corresponds to a time domain unit meeting a specific requirement, and the first object includes at least one of the following: at least two SRS resource sets or at least two SRS configurations. The terminal embodiment corresponds to the foregoing terminal-side method embodiment, and all implementation processes and implementations of the foregoing method embodiment are applicable to the terminal embodiment, with the same technical effect achieved.

For example, FIG. 9 is a schematic diagram of a hardware structure of a terminal for implementing embodiments of this application.

The terminal 900 includes but is not limited to at least some of the following components: a radio frequency unit 901, a network module 902, an audio output unit 903, an input unit 904, a sensor 905, a display unit 906, a user input unit 907, an interface unit 908, a memory 909, a processor 910, and the like.

Persons skilled in the art can understand that the terminal 900 may further include a power supply (for example, a battery) that supplies power to each component. The power supply may be logically connected to the processor 910 through a power management system, so that functions such as charging management, discharging management, and power consumption management are implemented through the power management system. The terminal structure shown in FIG. 9 does not constitute a limitation on the terminal. The terminal may include more or fewer components than those shown in the figure, or some components may be combined, or different component arrangements may be used. Details are not described herein again.

It should be understood that, in this embodiment of this application, the input unit 904 may include a Graphics Processing Unit (GPU) 9041 and a microphone 9042. The graphics processing unit 9041 processes image data of a static picture or a video that is obtained by an image capture apparatus (for example, a camera) in a video capture mode or an image capture mode. The display unit 906 may include a display panel 9061. The display panel 9061 may be configured in a form of a liquid crystal display, an organic light-emitting diode, or the like. The user input unit 907 includes at least one of a touch panel 9071 and other input devices 9072. The touch panel 9071 is also referred to as a touchscreen. The touch panel 9071 may include two parts: a touch detection apparatus and a touch controller. The other input devices 9072 may include but are not limited to a physical keyboard, a function button (such as a volume control button or an on/off button), a trackball, a mouse, and a joystick. Details are not described herein.

In this embodiment of this application, after receiving downlink data from a network-side device, the radio frequency unit 901 may transmit the downlink data to the processor 910 for processing. In addition, the radio frequency unit 901 may transmit uplink data to the network-side device. Usually, the radio frequency unit 901 includes but is not limited to an antenna, an amplifier, a transceiver, a coupler, a low noise amplifier, a duplexer, and the like.

The memory 909 may be configured to store software programs or instructions and various data. The memory 909 may mainly include a first storage region for storing a program or instructions and a second storage region for storing data. The first storage region may store an operating system, an application or instructions required by at least one function (for example, an audio play function or an image play function), and the like. In addition, the memory 909 may include a volatile memory or a non-volatile memory, or the memory 909 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), or a Direct Rambus RAM (DRRAM). The memory 909 in this embodiment of this application includes but is not limited to these and any other suitable types of memories.

The processor 910 may include one or more processing units. For example, the processor 910 integrates an application processor and a modem processor. The application processor mainly processes operations related to an operating system, a user interface, an application, and the like. The modem processor mainly processes wireless communication signals, for example, is a baseband processor. For example, it can be understood that the modem processor may not be integrated in the processor 910.

The radio frequency unit 901 is configured to receive first configuration information from a network-side device, where in the first configuration information, a maximum of M sets of configuration information are configured for a single SRS resource, each set of configuration information corresponds to a time domain unit meeting a specific requirements, and Mis an integer greater than 1; and/or the first configuration information is used for configuring a first object, the first object, after being configured, corresponds to a time domain unit meeting a specific requirement, and the first object includes at least one of the following: at least two SRS resource sets or at least two SRS configurations.

The terminal 900 provided in this embodiment of this application is capable of implementing the processes implemented in the method embodiment shown in FIG. 3, with the same technical effect achieved. To avoid repetition, details are not described herein again.

An embodiment of this application further provides a network-side device, including a processor and a communication interface. The communication interface is configured to send first configuration information to a terminal, where in the first configuration information, a maximum of M sets of configuration information are configured for a single SRS resource, each set of configuration information corresponds to a time domain unit meeting a specific requirements, and M is an integer greater than 1; and/or the first configuration information is used for configuring a first object, the first object, after being configured, corresponds to a time domain unit meeting a specific requirement, and the first object includes at least one of the following: at least two SRS resource sets or at least two SRS configurations. The network-side device embodiment corresponds to the foregoing method embodiment for the network-side device, and all implementation processes and implementations of the foregoing method embodiment are applicable to the network-side device embodiment, with the same technical effect achieved.

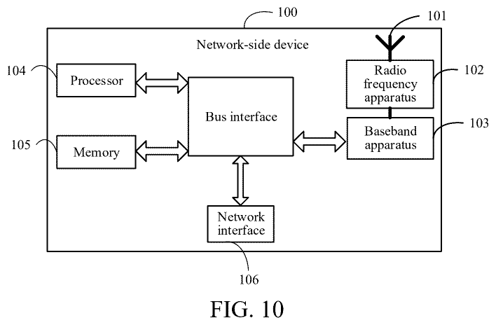

For example, an embodiment of this application further provides a network-side device. As shown in FIG. 10, the network-side device 100 includes an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101, and sends the received information to the baseband apparatus 103 for processing. In a downlink direction, the baseband apparatus 103 processes to-be-sent information, and sends the information to the radio frequency apparatus 102; and the radio frequency apparatus 102 processes the received information and then sends the information through the antenna 101.

The method performed by the network-side device in the foregoing embodiments may be implemented in the baseband apparatus 103, and the baseband apparatus 103 includes a baseband processor.

The baseband apparatus 103 may include, for example, at least one baseband board, where a plurality of chips are disposed on the baseband board. As shown in FIG. 10, one of the chips is, for example, the baseband processor, which is connected to the memory 105 through a bus interface, to invoke a program in the memory 105 to perform the operations of the network device shown in the foregoing method embodiments.

The network-side device may further include a network interface 106. The interface is, for example, a Common Public Radio Interface (CPRI).

For example, the network-side device 100 in this embodiment of the present disclosure further includes instructions or a program stored in the memory 105 and capable of running on the processor 104, and the processor 104 invokes the instructions or program in the memory 105 to perform the method performed by the modules shown in FIG. 7, with the same technical effect achieved. To avoid repetition, details are not described herein again.

An embodiment of this application further provides a readable storage medium. The readable storage medium stores a program or instructions. When the program or instructions are executed by a processor, the processes in the information configuration method embodiments are implemented, with the same technical effect achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or a compact disc.

An embodiment of this application further provides a chip. The chip includes a processor and a communication interface. The communication interface is coupled to the processor. The processor is configured to run a program or instructions to implement the processes in the information configuration method embodiments, with the same technical effect achieved. To avoid repetition, details are not described herein again.

It should be understood that the chip provided in this embodiment of this application may also be referred to as a system-level chip, a system on chip, a chip system, a system-on-a-chip, or the like.

An embodiment of this application further provides a computer program or program product. The computer program or program product is stored in a storage medium. The computer program or program product is executed by at least one processor to implement the processes in the information configuration method embodiments, with the same technical effect achieved. To avoid repetition, details are not described herein again.

An embodiment of this application further provides a communication system, including a terminal and a network-side device. The terminal may be configured to perform the steps of the information configuration method shown in FIG. 3. The network-side device may be configured to perform the steps of the information configuration method shown in FIG. 5

It should be noted that the terms “include”, “comprise”, or any other variation thereof in this specification are intended to cover a non-exclusive inclusion, so that a process, a method, an object, or an apparatus that includes a list of elements not only includes those elements but also includes other elements that are not expressly listed, or further includes elements inherent to such a process, method, object, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the shown or described order, but may also include performing functions in a substantially simultaneous manner or in a reverse order depending on the functions involved. For example, the described method may be performed in an order different from that described, and steps may be added, omitted, or combined. In addition, features described with reference to some examples may be combined in other examples.

According to the foregoing descriptions of the implementations, persons skilled in the art can clearly understand that the methods in the foregoing embodiments may be implemented by using software in combination with a necessary common hardware platform, or may be implemented by using hardware. However, in most cases, the former is an example implementation. Based on such an understanding, the technical solutions of this application essentially or the part contributing to the conventional technology may be implemented in a form of a computer software product. The computer software product is stored in a storage medium (for example, a ROM/RAM, a magnetic disk, or a compact disc), and includes several instructions for instructing a terminal (which may be a mobile phone, a computer, a server, an air conditioner, a network device, or the like) to perform the methods in the embodiments of this application.

The foregoing describes the embodiments of this application with reference to the accompanying drawings. However, this application is not limited to the foregoing specific implementations. The foregoing specific implementations are merely examples, but are not limitative. Inspired by this application, persons of ordinary skill in the art may further make many modifications without departing from the purposes of this application and the protection scope of the claims, and all the modifications shall fall within the protection scope of this application.

What is claimed is:

1. An information configuration method, comprising:
receiving, by a terminal, first configuration information from a network-side device, wherein
in the first configuration information, a maximum of M sets of configuration information are configured for a single Sounding Reference signal (SRS) resource, each set of configuration information corresponds to a time domain unit meeting a specific requirement, and M is an integer greater than 1; or
the first configuration information is used for configuring a first object, the first object, after being configured, corresponds to a time domain unit meeting a specific requirement, and the first object comprises at least one of the following: at least two SRS Resource Sets or at least two SRS configurations.

2. The information configuration method according to claim 1, wherein the time domain unit meeting the specific requirement comprises a first type of time domain units or a second type of time domain units, the first type of time domain units is any time domain unit with a valid uplink resource in an uplink Bandwidth Part (BWP) range, and the second type of time domain units is any time domain unit with a valid uplink resource only in an uplink sub-band range.

3. The information configuration method according to claim 2, wherein the first type of time domain units comprises at least one of the following:
a semi-static uplink time domain unit; or
a first semi-static flexible time domain unit, wherein in the first semi-static flexible time domain unit, all the frequency domain range corresponding to an uplink BWP can be used as valid uplink resources,
or
the second type of time domain units comprises at least one of the following:
a semi-static downlink time domain unit; or
a second semi-static flexible time domain unit, wherein in the second semi-static flexible time domain unit, only the frequency domain range corresponding to an uplink sub-band can be used as valid uplink resources.

4. The information configuration method according to claim 2, wherein when only a single set of configuration information is configured for a single SRS resource, the single set of configuration information corresponds to the first type of time domain units or the second type of time domain units;
or
when two sets of configuration information are configured for a single SRS resource and the two sets of configuration information comprise a first set of configuration information and a second set of configuration information, the first set of configuration information corresponds to the first type of time domain units, and the second set of configuration information corresponds to the second type of time domain units; or the first set of configuration information corresponds to the second type of time domain units, and the second set of configuration information corresponds to the first type of time domain units.

5. The information configuration method according to claim 4, wherein the method further comprises any one of the following:
when a time domain unit occupied by a first SRS resource in a first slot overlaps with a time domain unit of another type based on second configuration information, performing, by the terminal, one of the following: determining that the first SRS resource is invalid in the first slot, or when a first predefined condition is not met in at least one overlapping time domain unit of the another type, determining that the first SRS resource is invalid in the first slot;
when a time domain unit occupied by a second transmission on a first SRS resource in a second slot overlaps with a time domain unit of another type based on second configuration information, performing, by the terminal, one of the following: determining that the second transmission is invalid in the second slot, or when a first predefined condition is not met in at least one overlapping time domain unit of the another type, determining that the second transmission is invalid in the second slot;
when all time domain units occupied by a first SRS resource in a third slot are time domain units of another type based on second configuration information, performing, by the terminal, one of the following: determining that the first SRS resource is invalid in the third slot, or when a first predefined condition is met in none of the occupied time domain units of the another type, determining that the first SRS resource is invalid in the third slot; or
when all time domain units occupied by a third transmission on a first SRS resource in a fourth slot are time domain units of another type based on second configuration information, performing, by the terminal, one of the following: determining that the third transmission is invalid in the fourth slot, or when a first predefined condition is met in none of the occupied time domain units of the another type, determining that the third transmission is invalid in the fourth slot, wherein
the second configuration information is a single set of configuration information configured for the first SRS resource, or the second configuration information is a set of configuration information determined from two sets of configuration information configured for the first SRS resource; and
a time domain unit corresponding to the second configuration information is the first type of time domain units, and the time domain unit of the another type is the second type of time domain units; or a time domain unit corresponding to the second configuration information is the second type of time domain units, and the time domain unit of the another type is the first type of time domain units.

6. The information configuration method according to claim 4, wherein when only a single set of configuration information is configured for a first SRS resource and the single set of configuration information is used as applied configuration information, or when two sets of configuration information are configured for a first SRS resource and one set of configuration information is determined from the two sets of configuration information as applied configuration information based on a configuration or an indication, when an SRS transmission corresponding to the first SRS resource is determined by using the applied configuration information, the terminal performs one of the following:
not expecting that the first SRS resource overlaps with a time domain unit of another type in any slot for transmission, or not expecting that the first SRS resource does not meet a first predefined condition in at least one overlapping time domain unit of another type, when overlapping exists, in any slot for transmission;
not expecting that any SRS transmission corresponding to the first SRS resource overlaps with a time domain unit of another type, or not expecting that any SRS transmission corresponding to the first SRS resource does not meet a first predefined condition in at least one overlapping time domain unit of another type when overlapping exists;
not expecting that all time domain units occupied by the first SRS resource in any slot for transmission are time domain units of another type, or not expecting that all time domain units occupied by the first SRS resource in any slot for transmission are time domain units of another type, and that the first SRS resource does not meet a first predefined condition in each occupied time domain unit of the another type; or
not expecting that all time domain units occupied by any SRS transmission corresponding to the first SRS resource are time domain units of another type, or not expecting that all time domain units occupied by any SRS transmission corresponding to the first SRS resource are time domain units of another type, and that any SRS transmission corresponding to the first SRS resource does not meet a first predefined condition in each occupied time domain unit of the another type, wherein
a time domain unit corresponding to the applied configuration information is the first type of time domain units, and the time domain unit of the another type is the second type of time domain units; or a time domain unit corresponding to the applied configuration information is the second type of time domain units, and the time domain unit of the another type is the first type of time domain units.

7. The information configuration method according to claim 4, wherein the method further comprises at least one of the following:
when only a single set of configuration information is applied to SRS transmissions corresponding to a second SRS resource, for each SRS transmission occasion in which the corresponding SRS transmission cannot be performed, performing, by the terminal, a plus-one operation on a first counter, wherein the first counter is used for counting SRS transmission occasions in which the corresponding SRS transmissions cannot be performed; or
when two sets of configuration information are applied to SRS transmissions corresponding to a third SRS resource, when an SRS transmission corresponding to the third SRS resource is performed or partially performed once in the first type of time domain units, performing, by the terminal, a plus-one operation on a second counter, and when an SRS transmission corresponding to the third SRS resource is performed or partially performed once in the second type of time domain units, performing, by the terminal, a plus-one operation on a third counter, wherein the second counter is used for counting SRS transmissions in the first type of time domain units, and the third counter is used for counting SRS transmissions in the second type of time domain units.

8. The information configuration method according to claim 4, wherein when only a single set of configuration information is configured for a single SRS resource in a first SRS resource set, the method further comprises:
for a first transmission occasion, determining, by the terminal according to a predefined requirement, SRS resources valid for transmission in the first SRS resource set, or SRS transmissions valid for initiation among SRS transmissions corresponding to SRS resources in the first SRS resource set, wherein
the first SRS resource set is a single SRS resource set configured by a network-side device for the terminal, and the first transmission occasion is a single transmission occasion corresponding to the first SRS resource set; or
wherein the predefined requirement comprises at least one of the following:
a time domain unit occupied by an SRS resource in a slot corresponding to the first transmission occasion, or a time domain unit occupied by an SRS transmission corresponding to the SRS resource in the slot corresponding to the first transmission occasion, corresponds to a type of time domain units that is configured for the SRS resource and that is valid for transmission;
a first PRB is within a first frequency domain range, wherein the first frequency domain range is a frequency domain range of valid uplink resources corresponding to a time domain unit occupied by an SRS resource in a slot corresponding to the first transmission occasion; or
any PRB occupied by an SRS transmission is within a second frequency domain range, wherein the second frequency domain range is a frequency domain range of valid uplink resources corresponding to a time domain unit occupied by the SRS transmission in a slot corresponding to the first transmission occasion, wherein
the first PRB comprises any one of the following:
all PRBs at a first layer in a frequency domain hierarchical structure of the SRS resource;
all PRBs at a frequency hopping layer in a frequency domain hierarchical structure of the SRS resource; or
a union of PRBs corresponding to one or more SRS transmissions expected to occur for the SRS resource in a corresponding slot.

9. The information configuration method according to claim 2, wherein the first object comprises at least two SRS resource sets, and among the at least two SRS resource sets configured, at least one SRS resource set corresponds to the first type of time domain units, and other SRS resource sets except for the at least one SRS resource set correspond to the second type of time domain units;
or
when the first object comprises at least two SRS configurations, each of the at least two SRS configurations configured corresponds to the first type of time domain units or the second type of time domain units.

10. The information configuration method according to claim 9, further comprising any one of the following:
when a time domain unit occupied by a fourth SRS resource in a fifth slot overlaps with a time domain unit of another type based on third configuration information, performing, by the terminal, one of the following: determining that the fourth SRS resource is invalid in the fifth slot, or when a second predefined condition is not met in at least one overlapping time domain unit of the another type, determining that the fourth SRS resource is invalid in the fifth slot;
when a time domain unit occupied by a fourth transmission for a fourth SRS resource in a fifth slot overlaps with a time domain unit of another type based on third configuration information, performing, by the terminal, one of the following: determining that the fourth transmission is invalid in the sixth slot, or when a second predefined condition is not met in at least one overlapping time domain unit of the another type, determining that the fourth transmission is invalid in the sixth slot;
when all time domain units occupied by a fourth SRS resource in a seventh slot are time domain units of another type based on third configuration information, performing, by the terminal, one of the following: determining that the fourth SRS resource is invalid in the seventh slot, or when a second predefined condition is met in none of the occupied time domain units of the another type, determining that the fourth SRS resource is invalid in the seventh slot; or
when all time domain units occupied by a fifth transmission on a fourth SRS resource in an eighth slot are time domain units of another type based on third configuration information, performing, by the terminal, one of the following: determining that the fifth transmission is invalid in the eighth slot, or when a second predefined condition is met in none of the occupied time domain units of the another type, determining that the fifth transmission is invalid in the eighth slot, wherein
the fourth SRS resource is a single SRS resource in a second SRS resource set, the third configuration information is configuration information corresponding to the fourth SRS resource, and the second SRS resource set is any one of the at least two SRS resource sets; or the fourth SRS resource is a single SRS resource in a single SRS resource set configured for a specific usage in a first SRS configuration, the third configuration information is configuration information corresponding to the fourth SRS resource, and the first SRS configuration is any one of the at least two SRS configurations; and
a time domain unit corresponding to the second SRS resource set or the first SRS configuration is the first type of time domain units, and the time domain unit of the another type is the second type of time domain units; or a time domain unit corresponding to the second SRS resource set or the first SRS configuration is the second type of time domain units, and the time domain unit of the another type is the first type of time domain units.

11. The information configuration method according to claim 9, wherein when a corresponding SRS transmission is determined for a fourth SRS resource, the terminal performs one of the following:
not expecting that the fourth SRS resource overlaps with a time domain unit of another type in any slot for transmission, or not expecting that the fourth SRS resource does not meet a second predefined condition in at least one overlapping time domain unit of another type, when overlapping exists, in any slot for transmission;
not expecting that any SRS transmission corresponding to the fourth SRS resource overlaps with a time domain unit of another type, or not expecting that any SRS transmission corresponding to the fourth SRS resource does not meet a second predefined condition in at least one overlapping time domain unit of another type when overlapping exists;
not expecting that all time domain units occupied by the fourth SRS resource in any slot for transmission are time domain units of another type, or not expecting that all time domain units occupied by the fourth SRS resource in any slot for transmission are time domain units of another type, and that the first SRS resource does not meet a second predefined condition in each occupied time domain unit of the another type; or
not expecting that all time domain units occupied by any SRS transmission corresponding to the fourth SRS resource are time domain units of another type, or not expecting that all time domain units occupied by any SRS transmission corresponding to the fourth SRS resource are time domain units of another type, and that any SRS transmission corresponding to the fourth SRS resource does not meet a second predefined condition in each occupied time domain unit of the another type, wherein
the fourth SRS resource is a single SRS resource in a third SRS resource set, and the third SRS resource set is a single SRS resource set among the at least two SRS resource sets; or the fourth SRS resource is a single SRS resource in a single SRS resource set configured for a specific usage in a second SRS configuration, and the second SRS configuration is a single SRS configuration among the at least two SRS configurations; and
a time domain unit corresponding to the third SRS resource set or the second SRS configuration is the first type of time domain units, and the time domain unit of the another type is the second type of time domain units; or a time domain unit corresponding to the third SRS resource set or the second SRS configuration is the second type of time domain units, and the time domain unit of the another type is the first type of time domain units.

12. The information configuration method according to claim 9, wherein when the first object comprises at least two SRS resource sets, the method further comprises:
receiving, by the terminal, first non-fallback scheduling Downlink Control Information (DCI), wherein a first SRS resource indicator SRI in the first non-fallback scheduling DCI meets any one of the following:
an SRS resource set corresponding to a single SRS resource or an SRS resource subset, indicated by the first SRI, is an SRS resource set corresponding to a type of a time domain unit, in which a Physical Uplink Shared Channel (PUSCH) scheduled by the first non-fallback scheduling DCI is located; or
an SRS resource set corresponding to a single SRS resource or an SRS resource subset, indicated by the first SRI, is indicated based on the first non-fallback scheduling DCI.

13. The information configuration method according to claim 1, wherein the at least two SRS Resource Sets are configured for a usage, the usage is codebook or nonCodebook.

14. The information configuration method according to claim 2, wherein a first SRS Resource Set in the at least two SRS Resource Sets corresponds to the first type of time domain units or the second type of time domain units, a second SRS Resource Set in the at least two SRS Resource Sets corresponds to the second type of time domain units or the first type of time domain units.

15. An information configuration method, comprising:
sending, by a network-side device, first configuration information to a terminal, wherein in the first configuration information, a maximum of M sets of configuration information are configured for a single Sounding Reference signal (SRS) resource, each set of configuration information corresponds to a time domain unit meeting a specific requirements, and M is an integer greater than 1; or
the first configuration information is used for configuring a first object, the first object, after being configured, corresponds to a time domain unit meeting a specific requirement, and the first object comprises at least one of the following: at least two SRS resource sets or at least two SRS configurations.

16. The information configuration method according to claim 15, wherein the time domain unit meeting the specific requirement comprises a first type of time domain units or a second type of time domain units, the first type of time domain units is any time domain unit with a valid uplink resource in an uplink Bandwidth Part (BWP) range, and the second type of time domain units is any time domain unit with a valid uplink resource only in an uplink sub-band range.

17. The information configuration method according to claim 16, wherein the first type of time domain units comprises at least one of the following:
a semi-static uplink time domain unit; or
a first semi-static flexible time domain unit, wherein in the first semi-static flexible time domain unit, all the frequency domain range corresponding to an uplink BWP can be used as valid uplink resources;
or
the second type of time domain units comprises at least one of the following:
a semi-static downlink time domain unit; or
a second semi-static flexible time domain unit, wherein in the second semi-static flexible time domain unit, only the frequency domain range corresponding to an uplink sub-band can be used as valid uplink resources.

18. The information configuration method according to claim 15, wherein the first object comprises at least two SRS resource sets, and among the at least two SRS resource sets configured, at least one SRS resource set corresponds to the first type of time domain units, and other SRS resource sets except for the at least one SRS resource set corresponds to the second type of time domain units;
or
when the first object comprises at least two SRS configurations, each of the at least two SRS configurations configured corresponds to the first type of time domain units or the second type of time domain units.

19. The information configuration method according to claim 18, wherein when the first object comprises at least two SRS resource sets, the method further comprises:
sending, by the network-side device, first non-fallback scheduling Downlink Control Information (DCI), wherein a first SRI in the first non-fallback scheduling DCI meets any one of the following:
an SRS resource set corresponding to a single SRS resource or an SRS resource subset, indicated by the first SRI, is an SRS resource set corresponding to a type of a time domain unit, in which a Physical Uplink Shared Channel (PUSCH) scheduled by the first non-fallback scheduling DCI is located; or
an SRS resource set corresponding to a single SRS resource or an SRS resource subset, indicated by the first SRI, is indicated based on the first non-fallback scheduling DCI.

20. A terminal, comprising a processor and a memory storing instructions, wherein the instructions, when executed by the processor, t cause the processor to perform operations comprising:
receiving first configuration information from a network-side device, wherein
in the first configuration information, a maximum of M sets of configuration information are configured for a single Sounding Reference signal (SRS) resource, each set of configuration information corresponds to a time domain unit meeting a specific requirement, and M is an integer greater than 1; or
the first configuration information is used for configuring a first object, the first object, after being configured, corresponds to a time domain unit meeting a specific requirement, and the first object comprises at least one of the following: at least two SRS Resource Sets or at least two SRS configurations.
